(19) United States
(12) Patent Application Publication
(10) Pub. No.: US 2016/0047649 A1
(43) Pub. Date: Feb. 18, 2016

(54) MOBILE-ASSISTED DETERMINATION OF THE ALTITUDE OF A MOBILE DEVICE

(71) Applicant: QUALCOMM Incorporated, San Diego, CA (US)

(72) Inventors: Stephen William EDGE, Escondido, CA (US); Andreas Klaus WACHTER, Menlo Park, CA (US); Kirk Allan BURROUGHS, Alamo, CA (US); Guttorm OPSHAUG, Redwood City, CA (US); Carlos Manuel PUIG, Santa Clara, CA (US)

(21) Appl. No.: 14/826,987

(22) Filed: Aug. 14, 2015

Related U.S. Application Data
(60) Provisional application No. 62/038,177, filed on Aug. 15, 2014.

(51) Int. Cl. G01C 5/06; H04B 1/40

(52) U.S. Cl. CPC G01C 5/06; H04B 1/40

(57) ABSTRACT

A method of determining, at a server, an altitude of a mobile device, includes: receiving, at the server from the mobile device, a present barometric pressure at the mobile device; and determining, at the server, an altitude of the mobile device based on the present barometric pressure and a present reference barometric pressure at a known altitude.

### CROSS-REFERENCE TO RELATED APPLICATIONS

This application claims the benefit of U.S. Provisional Application No. 62/038,177, filed Aug. 15, 2014, entitled “MOBILE-ASSISTED DETERMINATION OF THE ALTITUDE OF A MOBILE DEVICE,” which is incorporated herein in its entirety.

### BACKGROUND

Knowing the altitude of a mobile device (alternatively referred to as an access terminal, a terminal, user equipment, etc.) may be useful or even critical in some situations. For example, if the user of a terminal is located in a tall building and has dialed an emergency call (e.g. by dialing “911” or “112”), the altitude of the terminal may be used to infer, or help infer, the floor of the building the terminal and thus the user is located on which may be critical to direct public safety responders to the user.

To determine the altitude of a mobile device accurately, a barometric pressure measurement by the mobile device may be used if a reference pressure for a known altitude (e.g., mean sea level or local ground level) is available. The reference pressure may be obtained, for example, from weather data and/or reference stations (e.g., base stations and/or access points at known locations that are equipped with a barometric pressure sensor). In a mobile based method, an altitude determination may be performed by the terminal itself, possibly with a server sending reference pressure information to the terminal. The reference pressure information may include a reference pressure level for a reference location nearby to the terminal (e.g., assumed at mean sea level) and local pressure variation information (e.g., a pressure gradient) for both space and time, to enable the terminal to determine its altitude at a location different to the reference location and at some later time. The reference pressure information may also allow the terminal to calibrate a pressure sensor of the terminal if the terminal is able to determine its altitude by other independent means (e.g., using GNSS positioning) and to compare its measured pressure with that predicted from the reference pressure for the independently-obtained altitude. In a mobile assisted method, by contrast, a server may determine the altitude of the terminal rather than the terminal.

### SUMMARY

An example method of providing pressure information from a mobile device may include: measuring a barometric pressure at the mobile device; determining a present barometric pressure based on the measured barometric pressure; and sending, from the mobile device toward a server, the present barometric pressure.

Implementations of such a method may, for example, further include one or more of the following features. The method may further include sending, from the mobile device toward the server, one or more calibration points comprising, indicating, and/or in some other manner corresponding to one or more previous a three-dimensional locations of the mobile device and one or more then-present barometric pressures at the mobile device. In certain instances, a calibration point may further comprise or otherwise indicate a date and time combination or the like, e.g., corresponding to a previous three-dimensional location and/or a then-present barometric pressure. In certain example implementations, a calibration point may further comprise or otherwise indicate: a speed or the like of the mobile device, e.g., possibly corresponding to a date and time; a velocity or the like of the mobile device, e.g., possibly corresponding to a date and time; motion state information for the mobile device, e.g., possibly corresponding to a date and time; one or more techniques used to determine, at least in part, a location (e.g., possibly a three-dimensional location) of the mobile device; an uncertainty or other like measure or value corresponding to a determined location (e.g., possibly a three-dimensional location) of the mobile terminal; one or more recalibration indications or the like, indicating, at least in part, as to whether the mobile device recalibrated or otherwise affected a pressure sensor output of a pressure sensor of the mobile device, e.g., possibly based on a three-dimensional location and the then-present barometric pressure; and/or the like or some combination thereof. By way of further example, in certain instances an uncertainty or other like measure or value corresponding to a determined location may correspond to an uncertainty volume, and which may in certain implementations include or otherwise indicate a confidence level or the like. In certain example implementations, the method may include having a mobile device send calibration points whose three-dimensional locations are determined to be within a particular region, e.g., an outdoor region, etc. In certain instances, a method may include having a mobile device send calibration points whose three-dimensional locations may be determined to be within a particular region (e.g., outdoors) with at least a threshold level of confidence. In certain instances, a method may include having a mobile device send a further (second) recalibration indication that may, for example, be indicative of a most-recent recalibration of the pressure sensor, which may have occurred after certain date and time combinations in the calibration points and which may not be indicated as part of any of an earlier (first) recalibration indication. In certain instances, a present barometric pressure and a then-present barometric pressures may further include: a pressure-sensor-output indication; a pressure adjustment parameter; an adjusted pressure based on the pressure-sensor-output indication and the pressure adjustment parameter; a temperature of the pressure-sensor; an uncertainty of the pressure-sensor-output indication; an uncertainty of the adjusted pressure; and/or the like or some combination thereof. In certain implementations, a method may further comprise: receiving a pressure recalibration parameter (e.g., from the server); and changing the pressure adjustment parameter using the pressure recalibration parameter. In certain implementations, a method may further comprise determining and storing the calibration points in memory, wherein sending the calibration points may comprise retrieving the calibration points from or otherwise accessing the memory. In certain implementations, a method may further comprise determining, e.g., based on at least some of the calibration points, one or more barometric pressure statistics, such as, e.g., a mean barometric pressure, a standard deviation for a barometric pressure, a duration of statistics collection, and/or the like or some combination there just to name a few examples; and sending, from the mobile device (e.g., toward (to) the server, possibly via one or more intermediary device(s)), the barometric pressure statistics. In certain implementations, a present barometric pressure may, for example, be sent by the mobile device using at least one of a SUPL session, an LPP message or an LPP/LPPe message.

An example of a mobile device includes: an antenna; a transceiver communicatively coupled to the antenna and configured to send and receive wireless signals via the antenna; a pressure sensor configured to measure barometric pressure and to provide a pressure-sensor output indicative of the measured barometric pressure; a memory; and a processor, communicatively coupled to the transceiver, the pressure sensor, and the memory and configured to: determine a present barometric pressure based on the measured barometric pressure; and send, toward a server via the transceiver and the antenna, the present barometric pressure.

Another example mobile device includes: means for measuring a barometric pressure; means for determining a present barometric pressure based on the measured barometric pressure; and means for sending, toward a server, the present barometric pressure.

An example processor-readable, non-transitory storage medium includes processor-readable instructions configured to cause a processor to: determine a present barometric pressure based on a measured barometric pressure; and send, toward a server, the present barometric pressure.

An example method of determining, at a server, an altitude of a mobile device includes: receiving, at the server from the mobile device, a present barometric pressure at the mobile device; and determining, at the server, an altitude of the mobile device based on the present barometric pressure and a present reference barometric pressure at a known altitude.

Implementations of such a method may include one or more of the following features. The method may further include: receiving, from the mobile device, calibration points each including a three-dimensional location of the mobile device and a then-present barometric pressure at the mobile device; determining an adjustment to the present barometric pressure based on the calibration points and historic reference barometric pressure information; and applying the adjustment when not zero to the present barometric pressure before determining the altitude of the mobile device. A calibration point may further include a date and time combination corresponding to a three-dimensional location and the then-present barometric pressure. A calibration point may further include: a speed of the mobile device corresponding to the date and time; a velocity of the mobile device corresponding to the date and time; motion state information for the mobile device corresponding to the date and time; one or more techniques used to determine the three-dimensional location of the mobile device; an uncertainty of the three-dimensional location of the mobile terminal; an indication as to whether the mobile device recalibrated a pressure sensor output of a pressure sensor of the mobile device based on the three-dimensional location and the then-present barometric pressure; and/or the like or some combination thereof. An uncertainty may correspond to an uncertainty volume, which may, e.g., include a confidence level. The method may further include: determining for each of the calibration points whether the three-dimensional location is outdoors, where the determining the adjustment to the present barometric pressure is based on the calibration points whose three-dimensional location is determined to be outdoors. In certain instances, each calibration point whose three-dimensional location is determined to be outdoors, for example, within at least a threshold level of confidence may be used to determine the adjustment to the present barometric pressure. The method may further include discounting or ignoring calibration points with date and time combinations before a most-recent of the calibration points which may include an indication that the mobile device recalibrated the pressure sensor output based on the three-dimensional location and the then-present barometric pressure. A present reference barometric pressure at the known altitude and the historic reference barometric pressure information may be obtained, for example, at least in part, from at least one of (1) local weather data, (2) a weather bureau, (3) an access point, base station, or other communication device with a trusted barometric pressure indication, (4) crowd-sourced barometric pressure indications from mobile devices at known locations. A present barometric pressure and each of the then-present barometric pressures may, for example, include at least one of (1) a pressure-sensor-output indication, (2) a pressure adjustment parameter, (3) an adjusted pressure based on the pressure-sensor-output indication and the pressure adjustment parameter, (4) a temperature of the pressure-sensor, (5) an uncertainty of the pressure-sensor-output, or (6) an uncertainty of the adjusted pressure. In certain instances, a method may further include receiving, at the server from the mobile device, present barometric pressure statistics at the mobile device, where determining the altitude of the mobile device is based at least in part on the present barometric pressure statistics. The present barometric pressure statistics may, for example, include at least one of (1) a mean barometric pressure, (2) a standard deviation for a barometric pressure, or (3) a duration of statistics collection. A present barometric pressure may, for example, be received at the server using at least one of a SUPL session, an LPP message or an LPP/LPPe message.

An example server includes: an antenna; a transceiver communicatively coupled to the antenna and configured to send and receive wireless signals via the antenna; and a processor, communicatively coupled to the transceiver and configured to: receive, from a mobile device via the antenna and transceiver, a present barometric pressure at the mobile device; and determine an altitude of the mobile device based on the present barometric pressure and a present reference barometric pressure at a known altitude.

Another example server includes: means for receiving, from a mobile device, a present barometric pressure at the mobile device; and means for determining an altitude of the mobile device based on the present barometric pressure at the mobile device and a present reference barometric pressure at a known altitude.

An example processor-readable, non-transitory storage medium includes processor-readable instructions configured to cause a processor to: receive, from a mobile device, a present barometric pressure at the mobile device; and determine an altitude of the mobile device based on the present barometric pressure and a present reference barometric pressure at a known altitude.

Items and/or techniques described herein may provide one or more of the following capabilities, as well as other capabilities not mentioned. Barometric pressure sensors may be calibrated. Barometric pressure measurement data points that may be unreliable, e.g., if measured by a sensor that was indoors, may be discounted or ignored in determining a calibration adjustment of a barometric pressure sensor. Barometric pressure measurements may be used to determine mobile device altitude. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 is a simplified diagram of a system for determining altitude of mobile devices, in accordance with certain example implementations.

FIG. 2 is a simplified diagram of potential locations of a mobile device over time, in accordance with certain example implementations.

FIG. 3 is a block diagram of components of one of the mobile devices shown in FIG. 1, in accordance with certain example implementations.

FIG. 4 is a block diagram of functional modules of the mobile device shown in FIG. 3, in accordance with certain example implementations.

FIG. 5 is a block diagram of components of a server shown in FIG. 1, in accordance with certain example implementations.

FIG. 6 is a block diagram of functional modules of the server shown in FIG. 5, in accordance with certain example implementations.

FIG. 7 is a block flow diagram of a method of determining altitude of a mobile device, in accordance with certain example implementations.

FIG. 8 is a message flow diagram of sample communications in the method shown in FIG. 7, in accordance with certain example implementations.

FIG. 9 is a block flow diagram of a method of providing pressure information from a mobile device, in accordance with certain example implementations.

FIG. 10 is a block flow diagram of a method of determining, at a server, an altitude of a mobile device, in accordance with certain example implementations.

### DETAILED DESCRIPTION

Techniques are discussed herein for mobile-assisted determination of the altitude of a mobile device and barometric pressure calibration. For example, a mobile device may measure a present pressure with a pressure sensor and provide to a server an indication of a present barometric pressure associated with the mobile device. The server may use the indication of the present barometric pressure associated with the mobile device, and a reference pressure at a known altitude, to determine an altitude of the mobile device. The mobile device may further provide additional information including historical pressures associated with the mobile device, and three-dimensional locations and times associated with the historical pressures. The additional information may further include statistical information for the present pressure (e.g., a mean and standard deviation of the present pressure over a short period of less than a minute). The server may use the additional information to determine the reliability and stability of the present barometric pressure indication from the mobile device (e.g., whether fluctuating or increasing or decreasing) and/or whether to adjust the indication of the present pressure associated with the mobile device in order to determine the altitude of the mobile device. The server may provide adjustment information to the mobile device so that the mobile device may calibrate its measurements and/or adjustments for future pressure determinations. These examples, however, are not exhaustive.

It should be noted that the terms “pressure”, “barometric pressure”, “air pressure” and “atmospheric pressure” are used herein interchangeably and refer to the pressure exerted by the Earth's atmosphere at any particular location and time. The location can be indoors, outdoors or in a vehicle as well as at mean sea level, at ground level, below ground level (e.g. in a subway or basement) or above ground level (e.g. on an upper floor of a building). As described later herein, air pressure and a measurement of air pressure can be affected by factors such as altitude, weather, building heating and air conditioning and by other factors.

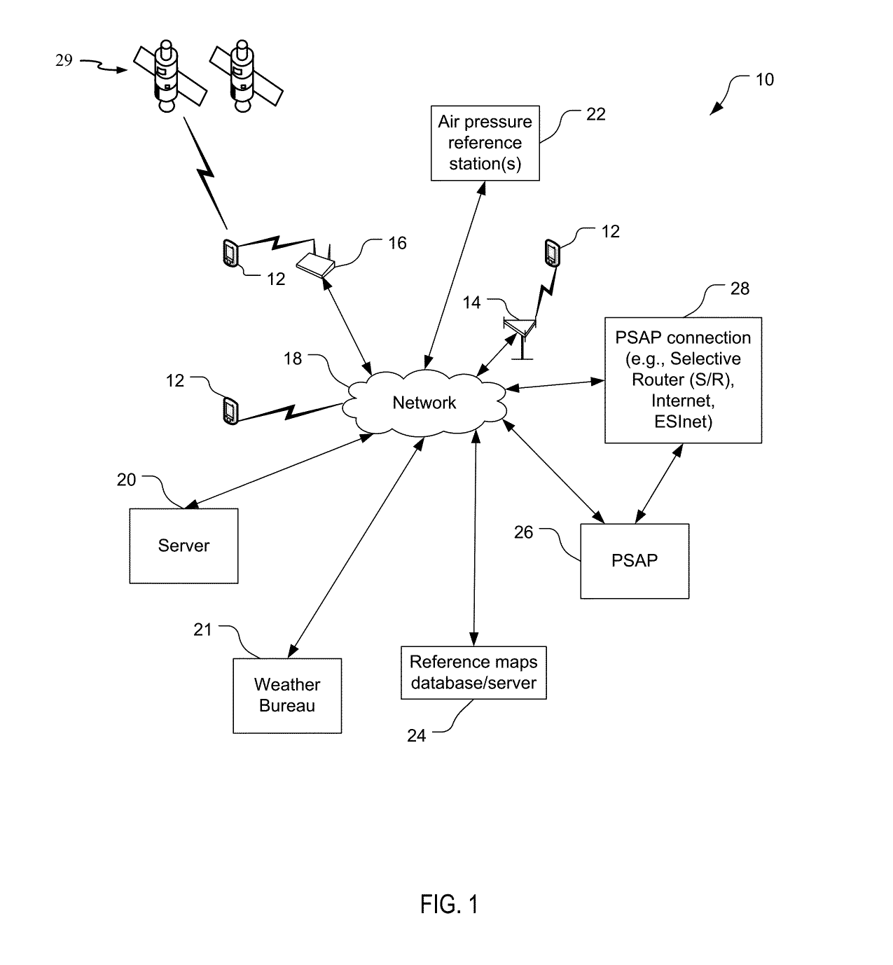

Referring to FIG. 1, a communication system 10 includes mobile devices 12, a base transceiver station (BTS) 14, an access point (AP) 16, a network 18, a server 20, one or more air pressure reference stations 22, a reference maps database/server 24, a Public Safety Answering Point (PSAP) 26, and a PSAP connection 28 such as a selective Router (S/R), the Internet, or an Emergency Service IP (Internet Protocol) network (ESInet) that is an IP capable network operated on behalf of the PSAP 26. The system 10 is a communication system in that the system 10 can at least send and receive communications. Although only one server 20 is shown for simplicity, more than one server 20 may be used in the system 10, e.g., in various locations to provide quicker access as the system 10 may span large regions, e.g., entire countries or continents, or even the planet. Further, although the reference maps database/server 24 is shown as a single entity, the reference maps database/server 24 may include one or more databases and/or one or more servers and these devices may be physically separate. Further still, although only one BTS 14 and one AP 16 are shown for simplicity, more than one BTS 14 and/or more than one AP 16 may be used in the system 10.

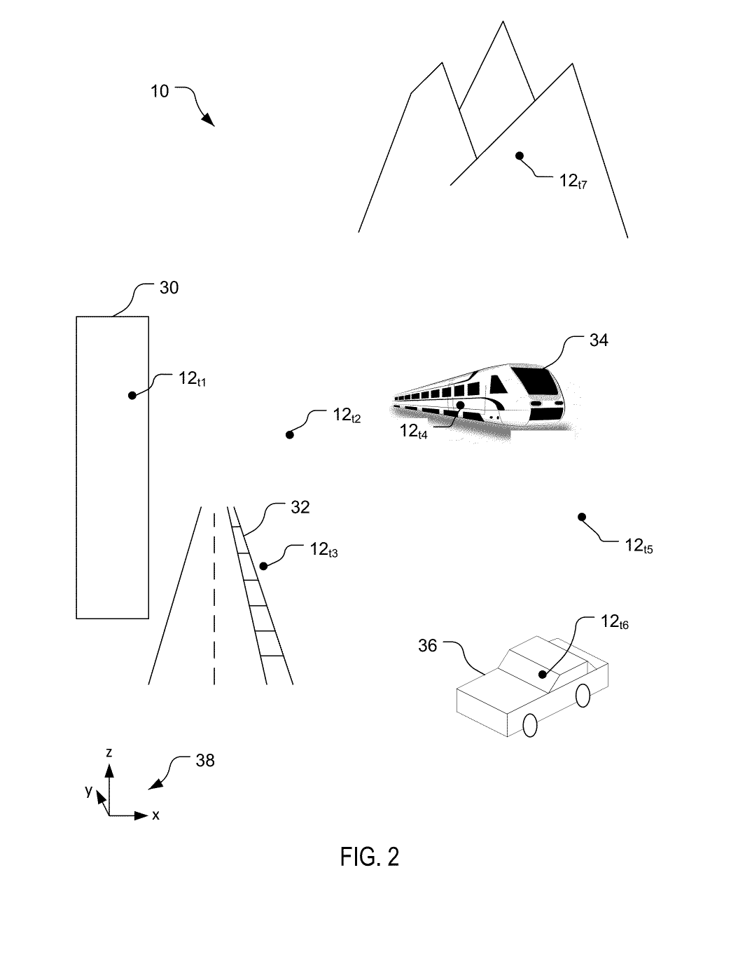

The mobile devices 12 may be referred to as access terminals (ATs), mobile stations (MSs), user equipments (UEs), terminals, mobile terminals, devices, subscriber units, wireless terminals, wireless devices, or by some other name. The mobile devices 12 are shown here as cellular phones. Other examples of mobile devices include wireless routers, personal digital assistants (PDAs), netbooks, notebook computers, tablet computers, laptops, smartphones, etc. Multiple potential locations for one mobile device 12 are shown in FIG. 2, and to simplify the discussion below only this mobile device 12 is discussed. In the description below, sometimes one mobile device 12 is referred to rather than all mobile devices in FIG. 1: in such cases, the mobile device 12 may be any one of mobile devices 12 in FIG. 1.

The BTS 14 can wirelessly communicate with the mobile devices 12 via antennas. The BTS 14 may also be referred to as an access node (AN), a base station, a Node B, an evolved Node B (eNodeB or eNB), etc. The BTS 14 may enable (e.g., may transfer) communication between the mobile devices 12 and the server 20 (e.g., via the network 18). BTS 14 may support one or more macrocells using one or more wireless technologies such as Global System for Mobile Communication (GSM), Code Division Multiple Access (CDMA) 2000 (cdma2000), High Rate Packet Data (HRPD), Wideband CDMA (WCDMA), Long Term Evolution (LTE) and may have a wireless coverage of several hundred meters or more. GSM, WCDMA and LTE are wireless technologies defined by the 3^{rd} Generation Partnership Project (3GPP). Cdma2000 and HRPD are wireless technologies defined by the 3^{rd} Generation Partnership Project 2 (3GPP2).

The AP 16 can be a femtocell, small cell, home base station, home Node B (HNB), home eNodeB (HeNB), WiFi access point (AP), Bluetooth® beacon, Bluetooth low energy (BTLE) beacon, or some other wireless access point that may act as a communications intermediary between the mobile device 12 and the network 18 and/or between the mobile device 12 and the server 20. The AP 16 may communicate directly with the network 18, but the AP 16 could also or instead communicate with the network 18 via the BTS 14. AP 16 may support one or more picocells or femtocells using one or more wireless technologies such as GSM, WCDMA, LTE, cdma2000 and/or may support non-cellular wireless technologies such as IEEE 802.11 WiFi or Bluetooth. AP 16 may have a wireless coverage of up to a hundred meters or a few hundred meters.

Network 18 may be a wireless wide area network (WWAN) such as a GSM, WCDMA, LTE, cdma2000 or HRPD network or may be a wireless local area network (WLAN) supporting IEEE 802.11 WiFi and/or Bluetooth. Network 18 may also be a wireline network such as the Internet or a satellite network. Although a single network 18 is shown in FIG. 1, network 18 may comprise a number of interconnected networks such as a number of WWANs and/or WLANs interconnected by the Internet. In some embodiments, BTS 14 and/or AP 16 may be part of network 18 or part of one network that is a part of network 18 when network 18 comprises multiple interconnected networks.

The BTS 14 and/or the AP 16 may provide reference pressure information. The BTS 14 and/or the AP 16 may each contain a pressure sensor capable of providing barometric pressure measurements, with the BTS 14 and/or the AP 16 communicating indications of the measured barometric pressures to the server 20. Thus, the BTS 14 and/or the AP 16 may be one of the air pressure reference station(s) 22. The server 20 may look up a known location of the BTS 14 and/or the AP 16, or location information may be provided by the BTS 14 and/or the AP 16. Also or alternatively, the BTS 14 and/or the AP 16 may obtain reference pressure and location information from the air pressure reference station(s) 22 and provide the pressure and location information to the server 20.

Reference station(s) 22 may obtain pressure related information (e.g. current pressure, pressure at a set of previous times, pressure statistics) from a barometric pressure sensor or sensors that are part of, collocated with or accessible from each reference station 22. Reference station(s) 22 may also be able to obtain information on other atmospheric related conditions such as temperature and/or humidity from other sensors that are part of, collocated with or accessible from each reference station 22. Reference station(s) 22 may provide atmospheric information (e.g. measurements, statistics) comprising barometric pressure and possibly other conditions such as temperature and/or humidity to server 20 and/or to weather bureau 21—e.g. via network 18. Reference station(s) 22 may also provide the location(s) of reference station(s) 22 (or of the sensor(s) used to obtain the atmospheric information) to server 20 and/or to weather bureau 21 along with atmospheric information and/or may provide identities for reference station(s) 22 to enable server 20 or weather bureau 21 to look up locations from preconfigured data for reference station(s) 22.

Weather bureau 21, which may also be referred to as a weather service, may provide weather related services and may obtain information to enable, or help enable, such services from reference station(s) 22. Weather bureau 21 may provide weather related information to server 20 (e.g. periodically or on request by server 20 and possibly via network 18) that may include current and/or historic barometric pressure, temperature and/or humidity related information (e.g. scalar values, rate of change with time, rate of change with distance) for a number of locations and possibly adjusted to some known reference altitude such as mean sea level.

In some embodiments, certain mobile devices 12 may provide (e.g. crowdsource) atmospheric information that may include barometric pressure, temperature and/or humidity to server 20 (e.g. via network 18). The information may be accompanied by the 3D location of a mobile device 12 (e.g. as obtained using a method like A-GNSS or inertial sensors that is not dependent on the atmospheric information) at the time of obtaining any atmospheric information. In the case of barometric pressure, a mobile device may provide a pressure measurement P, an adjustment A and/or a pressure measurement plus adjustment (P+A) as discussed further down. Server 20 may then combine atmospheric information from many mobile devices 12 (e.g. hundreds or thousands) to infer, or help infer, atmospheric pressure at different locations and at different times.

Communication system 10 may also include one or more satellite vehicles (SVs) 29 belonging to one or more global satellite navigation systems (GNSSs) such as GPS, Galileo, Glonass or Beidou and/or to regional satellite positioning systems (SPSs) such as QZSS, EGNOS or WAAS. Mobile devices 12 may be capable of receiving and measuring (e.g. measuring pseudoranges) for signals received from SVs 29 belonging to one or more GNSSs and/or to one or more regional SPSs which may enable mobile device 12 to obtain its location and/or convey its location to another entity such as server 20—e.g. if mobile device 12 sends an obtained location or GNSS measurements of SVs (enabling determination of a location) to the other entity.

The server 20 may be a Secure User-Plane Location (SUPL) Location Platform (SLP) as defined by the Open Mobile Alliance (OMA) and may then function as a Home SLP (H-SLP) and/or as a Discovered SLP (D-SLP). The server may also be an enhanced Serving Mobile Location Center (E-SMLC), e.g., as defined by 3GPP, which may support the 3GPP control plane location solution for LTE. The server 20 is discussed in more detail below. The server 20 may support the SUPL location solution defined by OMA and/or the LPP and/or LPPe positioning protocols.

Referring to FIG. 2, a mobile device 12 may be moved (e.g., by the user of mobile device 12) to various locations over time. For example, one of the mobile devices 12 may be disposed in a structure (here a building) 30 at a time t1 (shown by a location 12ₜ₁), outdoors generally at a time t2 (shown by a location 12ₜ₂), along a sidewalk 32 at a time t3 (shown by a location 12ₜ₃), in a train 34 at a time t4 (shown by a location 12ₜ₄), in an open area outdoors such as a park at a time t5 (shown by a location 12ₜ₅), in a vehicle such as a car 36 at a time t6 (shown by a location 12ₜ₆), and outdoors in mountains at a time t7 (shown by a location 12ₜ₂). Each of the locations 12ₜ₁, 12ₜ₂, 12ₜ₃, 12ₜ₄, 12ₜ₅, 12ₜ₆ and 12ₜ₇ may be associated with different horizontal coordinates (e.g., different X,Y coordinates in a local mapping system or different latitude and longitude) and/or different altitudes (e.g., different Z coordinates in a local coordinate system or different altitudes relative to mean sea level).

The server 20 preferably can communicate with the AP 16 and/or the BTS 14 through the network 18, and with the mobile devices 12 either through the AP 16 via the network 18 or through the BTS 14 via the network 18. The APs 16 may be connected to the network 18 through hard-wired transceivers or may be part of the network 18 (or part of one network that is a part of network 18), and include wireless transceivers for communication with the mobile devices 12 and possibly with the BTSs 14. In FIG. 2, an x-y-z coordinate system 38 is shown such that horizontal locations may be given by x-y coordinates while altitude is given by a z coordinate. The x-y-z coordinate system may correspond to some local coordinate system (e.g., that can be defined relative to a city map, building plan, venue map, structural plan, etc.) or to a regional or country-specific coordinate system or may correspond to use of absolute latitude (for the x coordinate), longitude (for the y coordinate), and altitude above or below mean sea level or local ground level (for the z coordinate). As used herein, the location of a mobile device in the x-y-z coordinate system may be referred to as an x,y location, an X,Y location, a two dimensional (2D) location, a horizontal location or as x,y coordinates when altitude is not included and as an x,y,z location, X,Y,Z location, a three dimensional (3D) location or as x,y,z coordinates when altitude is included.

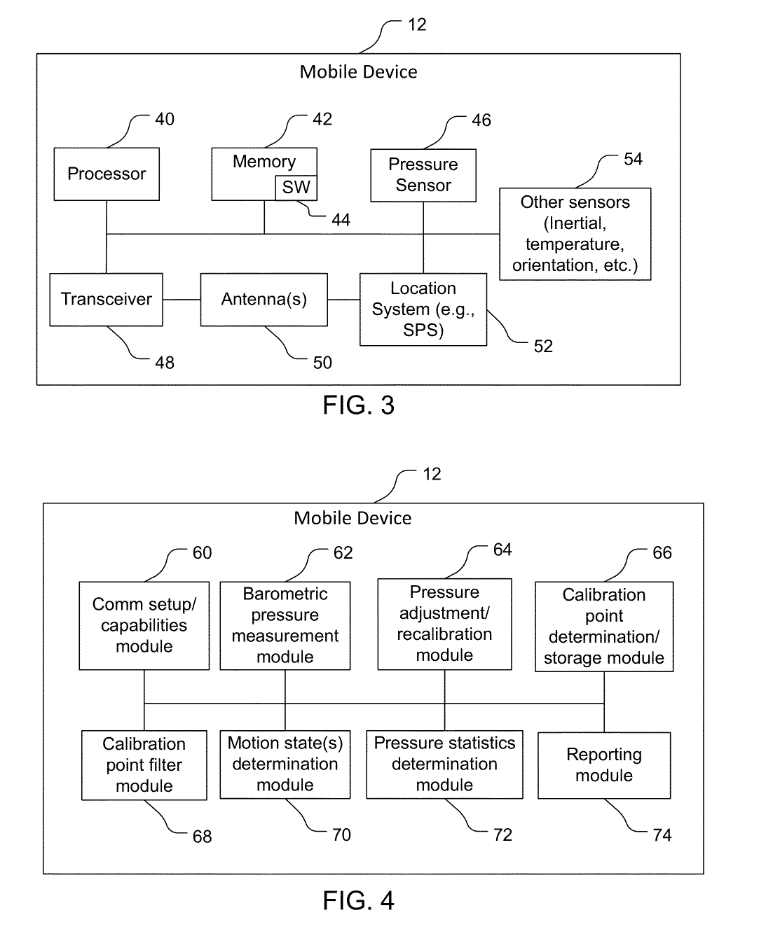

Referring to FIG. 3, with further reference to FIGS. 1-2, the mobile device 12 comprises a computer system including a processor 40, memory 42 including software (SW) 44, a pressure sensor 46, a transceiver 48, one or more antennas 50, a location system (e.g., a satellite positioning system (SPS)) 52, and one or more other sensors 54. The transceiver 48 and the antenna(s) 50 form a wireless communication module that can communicate bi-directionally with the BTS 14 and/or with the AP 16 and/or another entity. Thus, the antenna(s) 50 may include an antenna for communicating with the BTS 14 and/or an antenna (e.g. the same antenna or a different antenna) for communicating with the AP 16, and the transceiver 48 may include multiple transceivers, one for communicating with the BTS 14 and/or one (e.g. the same transceiver or a different transceiver) for communicating with the AP 16. The antenna(s) 50 may include an SPS antenna for receiving SPS signals (which may be the same antenna or a different antenna to the antenna or one of the antennas used to receive and transmit signals from and to the AP 16 and BTS 14) and the transceiver 48 may include an SPS receiver for processing and transferring the SPS signals to the processor 40.

The location system 52 may be configured to determine a three-dimensional location (e.g. x,y,z coordinates) of the mobile device 12. The location system 52 may use (e.g. may measure) satellite signals (e.g. from SVs 29), base station signals (e.g. from BTS 14), access point signals (e.g. from AP 16), and/or other signals to determine the location of the mobile device 12. The location system 52 may support positioning methods such as Assisted GNSS (A-GNSS), Observed Time Difference of Arrival (OTDOA), Enhanced Cell ID (E-CID), wireless local area network (WLAN or WiFi) based location, short range node (SRN) based location using BTLE beacons, location based on sensors (e.g. inertial sensors such as a gyroscope and/or accelerometers) and/or other methods. Support of A-GNSS, OTDOA, E-CID, WLAN/WiFi, SRN and/or sensor based location may be as defined by 3GPP (e.g., for the LPP positioning protocol (LPP) defined by 3GPP) and/or by the Open Mobile Alliance (OMA) (e.g., for the LPP Extensions (LPPe) protocol defined by OMA).

The processor 40 is preferably an intelligent hardware device, e.g., a central processing unit (CPU) such as those made by ARM®, Intel® Corporation, or AMD®, a microcontroller, an application specific integrated circuit (ASIC), etc. The processor 40 could comprise multiple separate physical entities that can be distributed in the mobile device 12. The memory 42 includes random access memory (RAM) and read-only memory (ROM). The memory 42 is a processor-readable non-transitory storage medium that stores the software 44 which is processor-readable, processor-executable software code containing processor-readable instructions that are configured to, when executed, cause the processor 40 to perform various functions described herein (although the description may refer only to the processor 40 performing the functions). Alternatively, the software 44 may not be directly executable by the processor 40 but configured to cause the processor 40, e.g., when compiled and executed, to perform the functions. The other sensors 54 may include one or more inertial sensors (e.g., one or more accelerometers, one or more gyroscopes), one or more magnetometers, a temperature sensor, an orientation sensor, etc.

The pressure sensor 46 is configured to measure a barometric pressure at the mobile device 12 and to provide an indication of the measured barometric pressure. The pressure sensor 46 may be configured to measure barometric pressure at the mobile device using one or more conventional techniques. The pressure sensor 46 may output an indication of the measured barometric pressure. Alternatively, the pressure sensor 46 may include a processor or controller that adapts the measured barometric pressure, e.g., based on measured temperature from the sensor 54 or another sensor (not shown in FIG. 3) that is an integral part of the pressure sensor 46, in accordance with calibration data, e.g., embedded in the pressure sensor during manufacture and possibly modified after manufacture. The pressure sensor 46 outputs an indication of the measured barometric pressure, with this indication being either the measured barometric pressure or the adapted pressure (e.g., wherein the pressure that is output by the pressure sensor 46 equals the measured pressure plus or minus some adaptation parameter). For the purposes of the description herein, the pressure that is output by the pressure sensor 46 will be referred to as the measured pressure whether or not the pressure sensor 46 applies an adaptation prior to output. The measured pressure will further sometimes be denoted herein by the symbol P and may be expressed in a number of different units such as in Pascals, millibars or millimeters or inches of mercury. Further, the pressure sensor 46 may be more than one physical sensor.

The pressure measurement that is output by the (barometric) pressure sensor 46 may be adapted by the mobile device 12 externally to the pressure sensor 46. For example, the memory 42 may contain calibration data obtained by the mobile device 12 at one or more previous times based on one or more pressure measurements from the pressure sensor 46 made at known x,y horizontal locations and altitudes z, where each altitude z is determined without reliance on the pressure sensor 46 (e.g., such as using SPS measurements from SVs 29). The mobile device 12 may compare each measured pressure with a pressure that is expected for the known altitude z based on reference pressure data (e.g., obtained from server 20) and determine one or more corrections, referred to herein as internal calibration data, for the measured pressure from the pressure sensor 46 (e.g., which may also be based on the temperature as provided by the sensors 54 or by the pressure sensor 46). In addition or alternatively, the vendor of the pressure sensor 46 may provide calibration data, referred to herein as external calibration data, to the mobile device 12 or to the vendor or network operator for the mobile device 12 for subsequent download to the mobile device 12. The external calibration data may include one or more corrections for the measured pressure from the pressure sensor 46 (e.g., which may be based on a temperature as provided by the sensors 54 or by the pressure sensor 46). The mobile device 12 (e.g., the processor 40) may determine an adjustment to the measured pressure P output by the pressure sensor 46. The adjustment may be based on internal calibration data and/or on external calibration data. The adjustment will sometimes be referred to herein by the symbol A which will be assumed to be a signed (e.g., positive or negative) number and may be expressed in the same units as the pressure P. In certain cases, the mobile device 12 may transfer one or more of the measured pressure output P of the pressure sensor 46, the adjusted pressure P+A (e.g., computed by the processor 40) which may comprise the measured pressure P plus the adjustment A, and/or the adjustment A to the server 20. In some cases the adjustment A may be (i) a function of the pressure measurement P, (ii) a function of the temperature T for the pressure sensor 46 or (iii) a function of both P and T. The function may be implemented as a lookup table, as a mathematical equation, or by other means.

Referring to FIG. 4, with further reference to FIG. 3, the mobile device 12 includes a communication setup/capabilities module (means for setting up a communication and means for providing capabilities) 60, a barometric pressure measurement module (means for measuring barometric pressure) 62, a pressure adjustment/recalibration module (means for adjusting pressure and/or means for recalibrating pressure) 64, a calibration point determination/storage module (means for determining and storing calibration points) 66, a calibration point filter module (means for filtering calibration points) 68, a motion state(s) determination module (means for determining motion state(s)) 70, a pressure statistics module (means for determining pressure statistics) 72, and a reporting module (means for reporting) 74. The modules 60, 62, 64, 66, 68, 70, 72, 74 are functional modules implemented by the processor 40 and the software 44 stored in the memory 42. Thus, reference to any of the modules 60, 62, 64, 66, 68, 70, 72, 74 performing or being configured to perform a function is shorthand for the processor 40 performing or being configured to perform the function in accordance with the software 44 (and/or firmware, and/or hardware of the processor 40). Similarly, reference to the processor 40 performing one or more functions discussed with respect to the modules 60, 62, 64, 66, 68, 70, 72, 74 is equivalent to one or more of the respective modules 60, 62, 64, 66, 68, 70, 72, 74 performing the function(s).

The communication setup/capabilities module 60 may be configured to place calls, establish communication sessions, and provide indicia of capabilities of the mobile device 12. The module 60 may place calls, e.g., an emergency call to the PSAP 26 (e.g., via the network 18, the BTS 14 and/or via the AP 16). The module 60 may establish, or assist in the establishment of, a communication session, such as a Secure User Plane Location (SUPL) session with the server 20 in response to the server 20 being made aware (e.g. by network 18) of an emergency call and contacting the mobile device 12. The module 60 may respond to a request, e.g., from the server 20, for the capabilities (e.g. positioning capabilities) of the mobile device 12 by sending, e.g., to the server 20, indicia of capabilities, e.g., whether the mobile device 12 has barometric-pressure-sensing and reporting capabilities.

The module 60 may provide capabilities of the mobile device 12, e.g., to the server 20. In particular, for sensor-based techniques for location determination (e.g., to determine the altitude of the mobile device 12), the module 60 may provide capabilities of the mobile device 12, e.g., in response to a request by the server 20. An example of such capabilities, here an OMA-LPPe-Sensor-ProvideCapabilities parameter as possibly supported by the LPPe protocol, is provided in EXHIBIT A. The format and encoding shown in Exhibit A conforms to Abstract Syntax Notation One (ASN.1), as defined by the International Telecommunications Union (ITU).

EXHIBIT A

| OMA-LPPe-Sensor-ProvideCapabilities ::= SEQUENCE { | | |
|---|---|---|
| motionStateSupport | NULL | OPTIONAL, |
| secondarySupport | NULL | OPTIONAL, |
| . . ., | | |
| atmosphericPressureADSupport | NULL | OPTIONAL, |
| atmosphericPressureSupport | NULL | OPTIONAL, |
| } | | |

In this example, for sensor-based location determination techniques supported by the LPPe protocol, the mobile module 60 may provide indications (e.g. to the server 20) that: (i) the mobile device 12 supports motion state measurements (and possibly provision of such measurements or indications of motion state(s)), such as by providing the indication of support in the motionStateSupport parameter in Exhibit A; (ii) supports secondary motion state measurements (and possibly provision of such measurements or indications of motion state(s)), such as by providing the indication of support in the secondarySupport parameter in Exhibit A; (iii) supports use of barometric pressure assistance data (e.g., for the mobile device 12 to determine altitude at the mobile device 12), such as by providing the indication of support in the atmosphericPressureADSupport parameter in Exhibit A (which may also be referred to as a barometricPressureSupport parameter); and/or (iv) supports atmospheric pressure measurements (e.g., that may be provided by the mobile device 12 to the server 20), such as by providing the indication of support in the atmosphericPressureSupport parameter in Exhibit A.

The barometric pressure measurement module 62 may be configured to measure barometric pressure and provide an indication, P, of the measured barometric pressure, which may correspond to a pressure measurement output P by the pressure sensor 46 as described earlier. The module 62 may comprise the pressure sensor 46 and may provide the indication P of the measured barometric pressure, with the indication P being the measured barometric pressure. The module 62 may also determine an adjustment A to the pressure P where the adjustment A may be calculated by the processor 40 as described earlier. The module 62 may further determine the adapted pressure P+A (the measured barometric pressure adapted by a processor or controller of the pressure sensor 46 or adapted by the processor 40), calibration data of the pressure sensor 46, or other indications of pressure associated with the mobile device 12.

The pressure adjustment/recalibration module 64 may be configured to determine and provide additional information to the server 20 to help the server 20 determine whether an indication of a present barometric pressure provided by the mobile device 12 is correct or should be adjusted in order to determine an altitude of the mobile device 12. The module 64 may determine a measured barometric pressure P, an adjustment parameter A, a confidence parameter C, a range or offset parameter R, and/or a temperature parameter T.

As described earlier, the adjustment parameter A may be applied (e.g., by the processor 40, by a wireless baseband processor, etc.) in the mobile device 12 external to the pressure sensor 46. The adjustment parameter A may further compensate for errors caused by temperature and/or inaccurate calibration of the pressure sensor 46. Thus, the adjustment parameter A may be a calibration of the pressure sensor 46 (or at least a calibration of an output of the pressure sensor 46 and thus effectively a calibration of the pressure sensor 46). Due to changes in the behavior of the pressure sensor 46 over time (e.g. over a few months or a year), the adjustment parameter A may need to change in order to enable an accurate adjusted pressure P+A; the change in the adjustment parameter A in this case may be considered a recalibration of the pressure sensor 46 or the output of the pressure sensor 46. The adjustment parameter A may be associated with internal calibration data and may be determined at least in part by the module 64 by comparing the pressure measured by the pressure sensor 46 at a known location with an expected pressure for the same location derived from reference information provided by the server 20 (e.g., air pressure at sea level, air pressure on the ground floor of a building measured by an accurate barometric sensor, and/or air pressure measured in one or more others of the air pressure reference station(s) 22). The adjustment parameter A may instead or in addition be determined, at least in part, by the pressure adjustment/recalibration module 64 using external calibration data provided by a vendor of the pressure sensor 46 and possibly stored in calibration point determination/storage module 66. The adjustment parameter A may be obtained using a mathematical function, a sequence of mathematical functions, a lookup table, an algorithmic process, a single value or some combination of these. For example, the adjustment parameter A may be dependent on temperature, having different values at different temperatures, and may then be obtained by applying a lookup table, an algorithm or a mathematical function to a current temperature. Further, the adjustment parameter A may be zero, or not determined, or not applied, such that a present barometric pressure provided by the mobile device 12 is the pressure measurement P as provided by the pressure sensor 46, i.e., a pressure-sensor output.

The confidence parameter C may be used to provide an uncertainty for an adjusted pressure measurement (e.g., P+A). The module 64 may determine the uncertainty as a probability or confidence C (e.g., expressed as a probability value between 0 and 1 or as a percentage) that the correct barometric pressure at the mobile device 12 is in a range from P+A−R to P+A+R, where R is a pressure range or offset parameter (e.g. expressed in the same units as the pressure P and/or the adjustment A) that expresses an uncertainty range, P is the pressure measurement from the pressure sensor 46, and A is the adjustment calculated by the module 62.

The module 64 obtains the temperature T from the sensor(s) 54 or from the pressure sensor 46. The module 64 may determine and provide the temperature T and the server 20 may use the temperature T to further adjust the adjusted pressure measurement P+A or the pressure P (e.g. if the adjustment A is zero or is not provided). For example, the server 20 may have additional information (e.g., provided at an earlier time to the server 20 or to an operator of the server 20 by a vendor of the mobile device 12 or by a vendor of a component of the mobile device 12 such as the pressure sensor 46) which may not be known by the module 64 and may enable an adjustment of the adjusted pressure measurement P+A or the pressure P. For example, the server 20 may have additional information regarding the behavior and/or accuracy of the pressure sensor 46 as a function of temperature.

The mobile device 12 may send current (also referred to herein as present) pressure measurement information comprising the current pressure measurement P, the adjustment A, the confidence C, the pressure range or offset R and/or the temperature T to the server 20 using data (e.g. in an LPPe message) formatted as shown in Exhibit C. Although Exhibit C is shown and described later herein to support sending of pressure measurement data for calibration points, the same ASN.1 data shown in Exhibit C may be used to encode and send current pressure measurement information from the mobile device 12 to the server 20. For example referring to Exhibit C, the sensorMeasurement parameter may be used to encode the pressure measurement P, the adjustment parameter may be used to encode the adjustment A, the uncertainty parameter may be used to encode the confidence C and the pressure range or offset R and the temperature parameter may be used to encode the temperature T.

The module 64 may be further configured to recalibrate the mobile device 12 for determining future pressure adjustments to measured barometric pressures. For example, the module 64 may perform recalibration by modifying any mathematical function, lookup table or algorithm previously used to determine an adjustment A from a pressure measurement P, a temperature T, or a pressure measurement P and temperature T. The module 64 may use information received from the server 20 or from another source (e.g. an operator or vendor for the mobile device 12 or a vendor for the pressure sensor 46) to recalibrate the mobile device 12. For example, the module 64 may use information from the server 20 concerning an adjustment determined by the server to a current pressure measurement P and/or to a current adjustment A.

The calibration point determination/storage module 66 may be configured to determine calibration points for reporting to the server 20 to help the server 20 determine whether an indication of a present barometric pressure provided by the mobile device 12 (e.g., consisting of a current pressure measurement P and optionally an adjustment A) is correct or should be adjusted in order to determine an altitude of the mobile device 12. The module 66 may determine calibration points intermittently (e.g., periodically or when the mobile device is detected to have moved some threshold minimum distance), and may store calibration points in the memory 42. For example, the module 66 may determine calibration points every five minutes, every hour, or another periodic interval, and/or may determine calibration points aperiodically (e.g., whenever the mobile device 12 obtains a 3D location for other purposes such as to support an application or client that needs a 3D location of the mobile device 12). Further, the module 66 may store various calibration points, such as the most recent N (e.g., where N is between 1 and 10) calibration points or the calibration points obtained within the last M minutes (e.g., 60 minutes or 1440 minutes). In addition or alternatively, the module 66 may store older calibration points, e.g., all calibration points for the last D days (e.g., 10 days), one calibration point for each of the last D days (e.g., 10 days), etc. The module 66 may filter stored calibration points based on different criteria. For example, the module 66 may retain only one calibration point for each of a number of consecutive periods such as 1 hour, 12 hours, 24 hours, or some other period. The retained calibration point may be the one with the highest 3D location accuracy (e.g., as indicated by having the smallest location uncertainty volume), the highest vertical location accuracy (e.g. as indicated by having the most accurate z coordinate) and/or may correspond to a location that appears to be outdoors.

As indicated above, the stored and/or retained calibration points may be transferred to a server 20 to help the server 20 determine whether an adjustment by the server to the current pressure P and/or to the adjustment A is needed and, if so, the magnitude of the adjustment. The server 20 may use a reference pressure provided by the weather bureau 21 or a reference station (e.g. one or more of air pressure reference stations 22) to determine the barometric pressure expected at the location for any calibration point at the date and time for the calibration point and compare this with the pressure measurement P and any adjustment A for the calibration point. If the expected pressure differs from the pressure measurement P or from the adjusted pressure P+A, the server 20 can compute a further adjustment to P or to P+A for alignment. The server 20 can do the same for other calibration points and combine any adjustments. If, on the other hand, the expected pressure is the same as or nearly the same as the pressure measurement P or the adjusted pressure P+A, the server 20 can assume that the pressure measurement P or the adjusted pressure P+A for the calibration point is accurate which may mean (e.g., if this applies to other calibration points as well) that the server 20 does not need to compute a further adjustment to P or to P+A for alignment.

In the case that a location for a calibration point corresponds to (or appears to correspond to) an outdoor location (e.g. as determined by the server 20 using a map), the server 20 may independently verify the altitude portion of the location for the calibration point by using a terrain map. A terrain map may enable a server 20 to look up the ground level for any horizontal x,y location. If a calibration point is (or appears to be) outdoors, then the location will typically be at ground level. The server 20 can then use a terrain map to compare the altitude implied by the terrain map with the altitude contained in the location. If the two are the same or at least consistent with one another, the server 20 may assume that the location for the calibration point is indeed at ground level. The server 20 may then compare the air pressure expected at the location (now inferred to be outdoors and at ground level) and at the date and time for the calibration point with the pressure P and/or pressure P plus adjustment A for the calibration point as previously described to help determine any needed adjustment by the server. Providing calibration points to a server 20 that are inferred to be outdoors by a mobile device 12 and using such calibration points in a server 20 may enable more reliable and accurate determination by the server 20 of any server adjustment. This may be due to being able to independently verify the altitude of a calibration point by the server 20 and/or to being able to more accurately determine the air pressure expected at a calibration point that is outdoors due to not having to make adjustments at the server 20 for indoor air pressure effects such as the stack effect, HVAC (heating, ventilation and air conditioning) and/or indoor airflow barriers.

The module 66 may be configured to provide the stored or the retained calibration points in response to a request from the server 20. The most-recently-determined calibration point may be considered to provide the “present” pressure at the mobile device 12 although any calibration point is for a time at least slightly in the past, and possibly several minutes or more in the past. The module 66 may also respond to a request for pressure information by causing the modules 62, 64 to measure the barometric pressure and adjust the measured barometric pressure as appropriate, and by producing a new calibration point.

Each of the calibration points produced by the module 66 preferably includes a three-dimensional location of the mobile device 12 (e.g., comprising x, y and z coordinates) and a pressure indication (e.g., comprising a measured pressure P and optionally a pressure adjustment A) indicative of the measured barometric pressure. Each calibration point may further include one or more of: (1) the date and time of the pressure measurement, (2) the speed and/or velocity of the mobile device at the date and time, (3) the user motion state(s) at the date and time (e.g. whether the user is stationary, walking, running, in a vehicle, on a train etc.), (4) the positioning method(s) used to determine the three-dimensional location, or (5) whether the mobile device 12 recalibrated the pressure sensor 46 based on any information in the calibration point, and if so, what pressure adjustment (recalibration) was applied. An example of a format, expressed using ASN.1, for providing the calibration points is provided in EXHIBIT B using a CalibrationPoints ASN.1 parameter.

EXHIBIT B

CalibrationPoints ::= SEQUENCE (SIZE (1 . . 10)) OF SEQUENCE {

| pressure | OMA-LPPe-PressureMeasurement, | |
|---|---|---|
| time | UTCTime, | |
| location | EllipsoidPointWithAltitudeAndUncertaintyEllipsoid, | |
| motionState | OMA-LPPe-Sensor-MotionStateList | OPTIONAL, |
| velocity | Velocity | OPTIONAL, |
| locationSource | OMA-LPPe-locationSource | OPTIONAL, |
| . . . | | |
| } | | |

The pressure parameter provided in the CalibrationPoints parameter in Exhibit B is the indication of the barometric pressure associated with the mobile device 12 at the date and time associated with the calibration point. For example, the pressure in the calibration point may include the indication, P, of the measured barometric pressure, the adjustment parameter A, the confidence C, the pressure range or offset parameter R, and/or the temperature T, as previously described. Alternatively, the pressure in the calibration point may be the indication of P only, the adjusted pressure (e.g., P+A) only, or the adjusted pressure (e.g., P+A) and the adjustment parameter A, or another indication of present atmospheric pressure associated with the mobile device 12. An example of the pressure parameter for a calibration point is provided in EXHIBIT C using ASN.1 encoding.

EXHIBIT C

OMA-LPPe-PressureMeasurement ::= SEQUENCE {

| | | |
|---|---|---|
| sensorMeasurement | INTEGER (30000 . . 115000), | |
| adjustment | INTEGER (-5000 . . 5000) | OPTIONAL, |
| uncertainty | SEQUENCE { | |

| | |
|---|---|
| range | INTEGER (0 . . 1000), |
| confidence | INTEGER (1 . . 100) |

| | | |
|---|---|---|
| | } | OPTIONAL, |
| temperature | INTEGER (-100 . . 150) | OPTIONAL, |
| . . . | | |
| } | | |

In this example, the present barometric pressure (expressed by the OMA-LPPe-PressureMeasurement parameter) comprises (i) a sensorMeasurement parameter that provides the pressure sensor measurement P as an integer value between 30,000 and 115,000 (e.g., in units of Pascal); (ii) optionally an adjustment parameter that provides the adjustment A as an integer value between −5,000 and 5,000 (e.g., in units of Pascal); (iii) optionally an uncertainty parameter comprising a range parameter that provides a pressure range or offset R as an integer value between 0 and 1000 (e.g. in units of Pascal (Pa)) and a confidence parameter that provides a confidence C expressed as an integer value between 1 and 100; and (iv) optionally a temperature parameter that provides a temperature T as an integer value between −100 and 150 (e.g., using the Celsius scale). The sensorMeasurement parameter may be obtained from the measured atmospheric pressure output of the pressure sensor 46 prior to any adjustment made externally to the pressure sensor 46. The adjustment parameter specifies any adjustment A applied to the output of the pressure sensor 46. The adjustment amount A may be determined (e.g. by pressure adjustment/recalibration module 64) based on internal calibration data and/or on external calibration data previously obtained by the mobile device 12 as described earlier herein. For example, internal calibration data can be based on previous calibration by the mobile device 12 of the pressure sensor 46 output using a known reference atmospheric pressure for a known location including altitude, whereas external calibration data can include temperature-related calibration data from a vendor of the pressure sensor 46. The adjustment A is preferably provided whenever available. If no adjustment A is available or if the adjustment is zero or is not obtained, then the adjustment parameter may be omitted, and may be assumed by the server 20 to have a value of zero. The uncertainty parameter provides the expected range R for the pressure measurement and the confidence C expressed as a percentage that the true atmospheric pressure lies in a range from measurement+adjustment-offset (e.g., P+A−R) to measurement+adjustment+offset (e.g., P+A+R). This field is optional but preferably provided if available. The temperature parameter provides the temperature T in degrees Celsius associated with the pressure sensor 46 used for the pressure measurement and is preferably provided if available. The temperature T of the pressure sensor 46 may be internal to the mobile device 12 and thus may differ from a temperature outside the mobile device, e.g., if a different sensor is used to measure outside temperature.

Returning to Exhibit B, the time parameter in the calibration point provides an absolute date and time using Coordinated Universal Time (UTC). The velocity parameter optionally indicates the direction and speed (e.g., provided by the motion state(s) determination module 70 discussed below) of the mobile device 12. The locationSource parameter optionally indicates what technique(s) was (were) used to determine the location such as use of A-GNSS, OTDOA, ECID, WLAN/WiFi based positioning, SRN positioning or other methods. The motionState parameter optionally indicates one or more motions states of the mobile device 12 associated with the user of the mobile device 12 (e.g., such as being stationary, walking, jogging, running, cycling, in a vehicle, in an elevator etc.) and is discussed in more detail below with respect to the module 70 and EXHIBIT D.

The location parameter for Exhibit B provides a three-dimensional location of the mobile device 12 and may be provided as a set of x,y,z coordinates together with an uncertainty and confidence for the x,y,z coordinates. The uncertainty may be expressed as a three-dimensional (3D) ellipsoid with the location given by the location parameter being at its center as defined in 3GPP Technical Specification (TS) 23.032. The confidence may be a percentage expressing the probability that the actual location of the mobile device 12 is within the 3D ellipsoid. In some embodiments, other types of coordinates, uncertainty and/or confidence may be used such as using polar or other types of Cartesian coordinates. Further, the module 66 may be configured to store one or more calibration points for later transfer to the server 20, for example according to the format in Exhibit B. For example, the module 66 may store at least one calibration point per designated time frame (e.g., one day) that has the lowest uncertainty (highest confidence) of location within the designated time frame. Alternatively, the module 66 may be configured to store at least one calibration point per designated time frame (e.g., one day) that has a location uncertainty lower than a threshold uncertainty (or a confidence above a threshold confidence) within the designated time frame. The uncertainty of each location may be determined approximately as an uncertainty volume given by the product of the x, y, and z uncertainty values for the location—e.g., the product of a horizontal semi-major length, horizontal semi-minor length and vertical height for an uncertainty volume given by a three-dimensional ellipsoid.

The calibration point filter module 68 may be configured to help ensure the accuracy of pressure readings of calibration points that are stored and/or reported by the mobile device 12. Thus, the module 68 may be part of the calibration point determination/storage module 66 such that preferably only calibration points with reliable pressures and/or reliable locations are stored (and thus reported), or the module 68 may be part of the reporting module 74 such that preferably only calibration points with reliable pressures and/or reliable locations are reported even if other calibration points are stored. For example, the module 68 may cause only calibration points to be stored and/or reported whose x-, y-, and z-coordinates are all determined within a threshold uncertainty. The module 68 may also or instead attempt to determine whether a calibration point location is outdoors, and to cause the module 66 to store and/or the reporting module 74 to report only calibration points whose locations are outdoors, or at least appear to be outdoors.

The module 68 may consider a number of separate metrics to determine whether the mobile device 12 is outdoors (or probably outdoors) or indoors (or probably indoors). For example, the mobile device 12 (e.g. the module 68) may consider a motion state for the mobile device with some motion states (e.g. walking or running over a time period of 5 minutes or more considered as more likely indicative of being outdoors and other motions states (e.g. being stationary or almost stationary for 5 minutes or more) as being more likely indicative of being indoors. The mobile device 12 (e.g. the module 68) may also consider signal strength as measured by the mobile device 12 from GNSS SVs such as SVs 29 with stronger signals (e.g. in the case of GPS close to the nominal outdoor value of −130 dBm) considered as indicative of being outdoors and with weaker signals for most or all detected SVs (e.g. below −140 dBm in the case of GPS) considered as indicative of being outdoors. The mobile device 12 (e.g. the module 68) may also consider the speed or velocity of the mobile device 12, a light or illumination level if measurable by the mobile device 12 (e.g. by a light sensor in other sensors 54), a background audio noise level (e.g. if measurable by a microphone of the mobile device 12), a current temperature (e.g. with a temperature below 15 Celsius or above 25 Celsius being considered as indicative of being outdoors), a current humidity, a sudden change in air pressure and/or altitude (e.g. which may be indicative of being indoors), and/or other metrics in determining whether a current location of mobile device 12 is (or is probably) indoors or outdoors. In determining whether the mobile device 12 is indoors or outdoors, the mobile device 12 (e.g. the module 68) may need to also determine whether the mobile device 12 may be in a vehicle, which may be considered as having attributes of being both indoors and outdoors, and may be considered as less desirable for a calibration point due to possible effects of a vehicle HVAC system in distorting an air pressure measurement. Mobile device 12 (e.g. module 68) may be able to determine and filter out calibration points for locations in vehicles based on a speed of the mobile device (e.g. above 30 kph) and/or on sensor measurements which may be able to detect motion consistent with being in a vehicle (or on train or airplane).

Locations that are outdoors (e.g. not in a vehicle or inside a building or structure) may be preferred for calibration points to allow for more accurate barometric pressure determinations (i.e., measurements and any adjustment(s)). Outdoor locations may also allow more accurate comparison of predicted barometric pressure to determined barometric pressure by enabling the prediction of pressure to consider weather conditions (which may be accurately known from a weather bureau 21 or the like) and/or information from one or more outdoor reference stations 22 without having to consider other factors such as building HVAC systems and the stack effect for a tall building. Conversely, prediction of air pressure at indoor locations or locations inside vehicles may be error prone, e.g., due to unknown effects of structure or vehicle air conditioning, heating, pressurization, or ventilation systems. Further, indoor air pressure is typically different from outdoor air pressure at the same altitude, e.g., due to effects of weather outdoors (e.g., wind), and differences between indoor temperature and humidity.

The motion state(s) determination module 70 may be configured to determine one or more motion states of the mobile device 12. The determined motion state(s) may be included in each corresponding calibration point. The module 70 analyzes sensor information from the other sensors 54 such as accelerometer information, gyroscope information, inertial information, etc. to determine whether the mobile device 12 is moving, speed and direction of movement, any movement pattern (e.g., vibration, cyclic up and down motion, etc.), etc. The module 70 may characterize the motion, or lack thereof, of the mobile device 12 as being of one or more motion states. The motion states may include unknown, stationary, pedestrian, running, cycling, car, train, airplane, boat, fidgeting, etc. The module 70 may determine a confidence level associated with any of the determined motion states, or of a combination of motion states. For example, the module 70 may provide a list of motion states for each calibration point, using an OMA-LPPe-Sensor-MotionStateList parameter formatted using ASN.1, as shown in Exhibit D.

EXHIBIT D

OMA-LPPe-Sensor-MotionStateList ::= SEQUENCE (SIZE(1..8)) OF OMA-LPPe-Sensor-
MotionStateElement
OMA-LPPe-Sensor-MotionStateElement ::= SEQUENCE {

| | |
|---|---|
| primaryMotionState | ENUMERATED { |
| | unknown, |
| | stationary, |
| | pedestrian, |
| | running, |
| | cycling, |
| | car, |
| | train, |
| | aeroplane, |
| | boat, |
| | fidgeting, |
| | ... |
| | }, |
| confidence | INTEGER(0..99), |

secondaryMotionState BIT STRING {

| | | |
|---|---|---|
| | stationary | (0), |
| | pedestrian | (1), |
| | running | (2), |
| | cycling | (3), |
| | car | (4), |
| | train | (5), |
| | aeroplane | (6), |
| | boat | (7), |
| | fidgeting | (8) } (SIZE(1..16)) OPTIONAL, |
| ... | | |
| } | | |

In the example in Exhibit D, the list of motion states included in the OMA-LPPe-Sensor-MotionStateList parameter allows for up to eight motion state elements (although other quantities could be used). Each motion state element (corresponding to the OMA-LPPe-Sensor-MotionStateElement ASN.1 parameter) contains one primary motion state (e.g., the motion state with highest sustained speed) and optionally one or more secondary motion states. This enables a description, for example, that a person carrying the mobile device 12 is on a train (primary motion state) and walking (secondary motion state). The confidence parameter represents the confidence of the primary motion state if no secondary motion state is included or the combination of the primary state and the secondary motion state(s) if one or more secondary motion states is(are) included. The primaryMotionState parameter in Exhibit D specifies the primary motion state (e.g., the state with the highest sustained speed). The confidence parameter in Exhibit D specifies the confidence that the mobile device 12 is in the indicated motion state(s). The confidence may be truncated as a percentage in the range 0 (zero) to 99. The secondaryMotionState parameter in Exhibit D specifies one or more secondary motion states. The secondary motion state(s) is (are) indicated by a bit string in which each bit position indicates a distinct secondary motion. The presence of two or more secondary motion states (e.g. represented by bits set to one) may indicate that all the indicated secondary motions exist concurrently, e.g., fidgeting while stationary while on a train. A secondary motion state may be set to zero (or false), and this may imply that the mobile device 12 is asserting that the motion state is not in effect. This example is not limiting and other techniques for indicating a motion state or motion states may be used. Alternatively, the mobile device 12 may provide data (e.g. output signals or data from one or more of other sensors 54) from which one or more motion states may be determined, rather than providing conclusions as to the motion state(s).

Returning to FIG. 4, the pressure statistics determination module 72 may be configured to determine statistics regarding multiple barometric pressures obtained at a current time or at recent previous times (e.g. over the previous minute). The barometric pressures may be measured barometric pressures and/or multiple altered barometric pressures, e.g., as output by the pressure sensor 46 and/or the mobile device 12 (e.g., after application of the adjustment parameter A discussed above). The module 72 may determine the mean pressure and the standard deviation of a set of pressure values. The pressure values are preferably indicative of the same pressure type (e.g., measured barometric pressure, altered barometric pressure). For example, the module 72 may provide pressure statistics, formatted according to ASN.1, as shown in Exhibit E.

EXHIBIT E

PressureStats ::= SEQUENCE{

| sensorMeanPressure | INTEGER | (30000 . . 115000), | |
|---|---|---|---|
| sensorStddevPressure | INTEGER | (0 . . 2000) | OPTIONAL, |
| duration | INTEGER | (5 .. 40), | |
| . . .} | | | |

The PressureStats parameter may correspond to the mean and (optional) standard deviation of the air pressure value being reported as a present barometric pressure for the mobile device 12 (e.g. preferably, the reported present barometric pressure is the pressure measurement P discussed above provided by the pressure sensor 46). The mean and standard deviation may be for the reported current pressure measurement P over the indicated duration (time period) immediately preceding the measurement of the barometric pressure P. The sensorMeanPressure parameter in Exhibit E may provide the mean pressure (e.g. in units of Pascals), the sensorStddevPressure parameter in Exhibit E may provide the standard deviation of the measured pressure (e.g. in units of Pascals) and the duration parameter in Exhibit E may provide the duration (e.g. as a period of between 5 to 40 seconds) over which the mean and standard deviation were determined. The pressureStats parameter in Exhibit E may help the server 20 remove noise or other variation from the reported present barometric pressure through averaging, and may help the server 20 evaluate the stability of the present barometric pressure (e.g., whether the present barometric pressure is increasing, decreasing, or constant). The module 72 may determine the pressure statistics while the mobile device 12 is performing other functions, e.g., that are requested by the server 20. The present barometric pressure (e.g., see pressureMeasurement field in EXHIBIT F below) is preferably obtained at the end of the duration for the PressureStats statistics. This example is not limiting and other techniques for providing information for pressure statistics and pressure stability may be used.

The reporting module 74 is configured to send indications of present barometric pressure, the calibration points, the pressure statistics, and other information to the server 20 or other desired destination. For example, in response to a request from the server for location information, the reporting module 74 may provide the requested location information, optionally including the current atmospheric pressure and other information (e.g., calibration points and/or pressure statistics). If the atmospheric pressure is available, then it is preferably provided. An example of atmospheric pressure data that may be conveyed by mobile device 12 to server 20 in an LPPe Provide Location Information message for providing the requested location information is provided below in EXHIBIT F using ASN.1 encoding.

EXHIBIT F

OMA-LPPe-AtmosphericPressure ::= SEQUENCE {

| pressureMeasurement | OMA-LPPe-PressureMeasurement, | |
|---|---|---|
| pressureStats | PressureStats | OPTIONAL, |
| calibrationPoints | CalibrationPoints | OPTIONAL, |
| . . .} | | |

An LPPe Provide Location Information message may include (e.g. encapsulate) the OMA-LPPe-AtmosphericPressure parameter shown in Exhibit F which may include (i) a pressureMeasurement parameter, which may provide the present atmospheric pressure at the mobile device 12 and an example of which is provided in EXHIBIT C as described previously; (ii) optionally a pressureStats parameter an example of which was discussed above with respect to EXHIBIT E; and (iii) optionally a calibrationPoints parameter an example of which was discussed above with respect to EXHIBIT B. The indication of the present barometric pressure associated with the mobile device 12 may be a most-recent pressure indication associated with the mobile device 12, thus being assumed to be the present pressure even though the pressure measurement was necessarily in the past (e.g. a few seconds in the past). The reporting module 74 may provide information as to the type of the pressure sensor 46, e.g., the vendor, model, and/or version of the pressure sensor 46. Further, the reporting module 74 may provide information to the server 20 or other recipient concerning a most recent recalibration of the pressure sensor 46 that occurred subsequent to any of the times of the calibration points reported by the reporting module 74 and that was not reported as part of any calibration point.

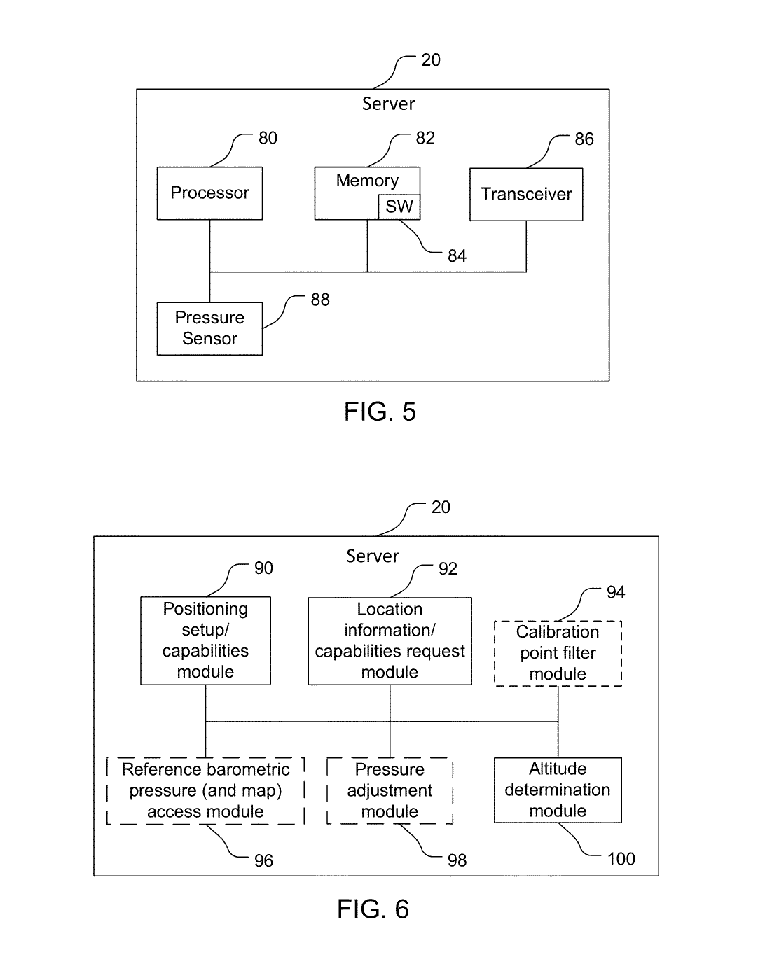

Referring to FIG. 5, with further reference to FIGS. 1-2, the server 20 comprises a computer system including a processor 80, memory 82 including software (SW) 84, a transceiver 86, and an optional pressure sensor 88. The transceiver 86 may communicate bi-directionally with other entities in the system 10 (and may do so wirelessly if the server 20 includes one or more appropriate antennas). The transceiver 86 may support communication with one or more of the mobile devices 12 (e.g., via the network 18) and may support communication according to signaling defined for the OMA SUPL location solution, the 3GPP LPP protocol and/or the OMA LPPe positioning protocol. The transceiver 86 may further support communication between the server 20 and other entities such as the air pressure reference station(s) 22, the reference maps database/server 24, the network 18 and/or the PSAP 26 in FIG. 1. The pressure sensor 88 is optional and if present is configured to measure atmospheric pressure at the server 20, e.g., for use as a reference pressure assuming the altitude of the server 20 is known. If the server 20 (or the pressure sensor 88 if separate from the server 20) is indoors, however, the pressure measured by the sensor 88 may not be very useful. As the server 20 will typically be indoors, the pressure sensor 88 may be omitted from the server 20. The processor 80 is preferably an intelligent hardware device, e.g., a central processing unit (CPU) such as those made by ARM®, Intel® Corporation, or AMD®, a microcontroller, an application specific integrated circuit (ASIC), etc. The processor 80 could comprise multiple separate physical entities that can be distributed in the server 20. The memory 82 includes random access memory (RAM) and read-only memory (ROM). The memory 82 is a processor-readable non-transitory storage medium that stores the software 84 which is processor-readable, processor-executable software code containing processor-readable instructions that are configured to, when executed, cause the processor 80 to perform various functions described herein for or in association with server 20 (although the description may refer only to the processor 80 performing the functions). Alternatively, the software 84 may not be directly executable by the processor 40 but configured to cause the processor 80, e.g., when compiled and executed, to perform the functions.

Referring to FIG. 6, with further reference to FIG. 5, the server includes a positioning setup/capabilities module (e.g. means for performing positioning) 90, a location information/capabilities request module (e.g. means for requesting location information and/or means for requesting capabilities) 92, optionally a calibration point filter module (e.g. means for filtering calibration points) 94, optionally a reference barometric pressure and map access module (e.g. means for obtaining reference barometric pressure and means for accessing map information) 96, optionally a pressure adjustment module (e.g. means for adjusting pressure indications) 98, and an altitude determination module (e.g. means for determining altitude) 100. The modules 90, 92, 94, 96, 98, 100 may be functional modules implemented by the processor 80 and the software 84 stored in the memory 82. Thus, reference to any of the modules 90, 92, 94, 96, 98, 100 performing or being configured to perform a function may be shorthand for the processor 80 performing or being configured to perform the function in accordance with the software 84 (and/or firmware, and/or hardware of the processor 80). Similarly, reference to the processor 80 performing one or more functions discussed with respect to the modules 90, 92, 94, 96, 98, 100 is equivalent to one or more of the respective modules 90, 92, 94, 96, 98, 100 performing the function(s).

The positioning setup/capabilities module 90 may be configured to establish communication sessions to perform positioning, for example in response to received requests. For example, the module 90 may establish a communication session (e.g., a SUPL communication session) with the module 60 (FIG. 4) of the mobile device 12 in response to an emergency call initiated by the mobile device 12 of which the server 20 becomes aware.

The location information/capabilities request module 92 may respond to a request, e.g., from the PSAP 26, for the location of a mobile device 12 by sending a request for location information to the mobile device 12. For example, for a sensor-based technique of determining mobile device location, or at least altitude of the mobile device location, the module 92 may send an LPPe Request Location Information (RLI) message (e.g. which may be embedded in an LPP RLI message) to the mobile device 12 containing an OMA-LPPe-Sensor-RequestLocationlnformation parameter. An example of this parameter, using ASN.1 encoding, is provided in EXHIBIT G.

EXHIBIT G

OMA-LPPe-Sensor-RequestLocationlnformation ::= SEQUENCE {

| | | |
|---|---|---|
| motionStateReq | OMA-LPPe-Sensor-MotionStateRequest | OPTIONAL, |
| . . ., | | |
| atmosphericPressureReq | OMA-LPPe-AtmosphicPressureRequest | OPTIONAL |
| } | | |

The motionStateReq parameter in Exhibit G may request information as to the motion state of the mobile device 12, and may be present if the server 20 requests primary motion state measurements and otherwise may not be present. The atmosphericPressureReq parameter in Exhibit G may request atmospheric pressure measurements and may be present if the server 20 requests atmospheric pressure measurements from the mobile device 12 and otherwise may not be present. The mobile device 12, e.g., the reporting module 74, may reply to the OMA-LPPe-Sensor-RequestLocationlnformation parameter by sending a corresponding LPPe Provide Location Information (PLI) message (e.g. which may be embedded in an LPP PLI message) with the requested pressure-related location information, e.g., with the OMA-LPPe-AtmosphericPressure parameter discussed above with respect to EXHIBIT F.

The LPPe RLI message that carries the OMA-LPPe-Sensor-RequestLocationlnformation parameter (and/or any LPP RLI message within which the LPPe RLI message is embedded) may request information from the mobile device 12 not shown in EXHIBIT G, e.g., A-GNSS and/or OTDOA measurements, for use by the server 20 to help determine the location, including horizontal location, of the mobile device 12. Alternatively, the server 20 may request non-pressure-related location information from the mobile device 12 in a separate LPP and/or LPPe RLI message and the mobile device 12 could reply in a corresponding separate LPP and/or LPPe PLI message with the requested non-pressure-related location information. This separate request/provide exchange could be performed before, concurrently, or after the exchange of the parameter shown in EXHIBIT G (and the corresponding response). Other combinations are also possible, e.g., with the server 20 using a network-based horizontal location (e.g., obtained using measurements of signals transmitted from mobile device 12 that are measured by entities in the network 18 such as the BTS 14 and the AP 16) and LPP and/or LPPe RLI/PLI messaging for pressure measurements. As previously described, each LPPe message referred to here may be embedded within a corresponding LPP message and may then be referred to as an LPP/LPPe message or as an LPP message.

The server 20 may include the calibration point filter module 94. For example, the module 94 may be omitted if the mobile device 12 filters calibration points before sending the calibration points to the server 20. Preferably, however, the server 20 includes the module 94, e.g., to filter sets of calibration points that are not filtered (or not completely, not reliably and/or not suitably filtered) by the reporting mobile device 12, particularly because the server 20 may have information that the mobile device 12 does not and therefore the module 94 may filter the calibration points differently than the mobile device 12 did or would.

The calibration point filter module 94 may be configured to help ensure the accuracy of, and/or help determine an adjustment for, a current pressure measurement P and/or an adjustment A that are provided by the mobile device 12 (e.g., according to exhibit F in an LPPe PLI or LPP/LPPe PLI message). The module 94 may be configured to analyze calibration points provided by the mobile device 12 and determine whether to use any particular calibration point(s) to determine whether and, if so, by how much to adjust a present pressure measurement P (and/or an adjustment A) reported by the mobile device 12 for determining altitude of the mobile device 12. For example, if a calibration point location is a 3D location with an uncertainty expressed using an ellipsoid volume, the module 94 may cause only calibration points to be used by the module 98 where x-, y-, and z-coordinates of the ellipsoid are all determined within a threshold accuracy (e.g., where the product of the uncertainties for each of the x, y and z coordinates, as expressed by the semi major axis, semi minor axis and height of the ellipsoid uncertainty volume, is less than some maximum). The module 94 may attempt to determine whether a calibration point location is outdoors (including not being inside a vehicle), and to cause the module 98 to use only calibration points whose locations are outdoors, or at least appear to be outdoors, as pressures determined at outdoor locations are typically more useful than pressures determined at indoor locations with respect to being predictable from reference pressure data such as weather data. For example, as with the module 68 (FIG. 4), the module 98 may analyze the motion state, location, and/or speed of the mobile device as of the time associated with a calibration point to determine whether a calibration point corresponds to an outdoor location or an indoor location.

For example, a server 20 that receives a set of calibration points from the mobile device 12, as exemplified for example by Exhibits B, C and D described above, may use the data for each calibration point to determine whether the location for the calibration point is (or is probably) indoors, outdoors or in a vehicle. The determination (e.g. by module 98) may be similar to or the same as that described previously for the mobile device 12 (e.g. module 68) determination of whether a location for a calibration point is (or is probably) indoors, outdoors or inside a vehicle. The server 20 (e.g. module 98) can use data for each calibration point (e.g. as exemplified in Exhibit B) such as the motion state(s) of the mobile device 12, the position source(s) for the location of the mobile device 12, the velocity of the mobile device 12 and the accuracy of the location of the mobile device 12 to help determine whether the location for a calibration point is (or is probably) indoors, outdoors or in a vehicle. The server 20 (e.g. module 98) can also use a terrain map to help infer an outdoor location as previously described herein. An ability for server 20 (e.g. module 98) to determine an indoor versus outdoor location may mean that mobile device 12 (e.g. module 68) need not always send only calibration points for outdoor (or probable outdoor) locations to server 20.

The module 94 may also or instead cause the module 98 to use calibration points whose locations are indoors, e.g., if the module 96 determines accurately a horizontal location of the mobile device 12 and determines a reference pressure at or nearby to the location of the mobile device 12 that is also for an indoor location in an environment (e.g., building) common to that of the location of the mobile device 12. For example, the module 96 may determine the reference pressure at an indoor location from one or more reference barometric pressure sensors at the indoor location (e.g., inside a building) and/or from crowd-sourced pressures provided by other mobile devices at known locations (e.g., and averaged) nearby to the location of the mobile device 12.

The module 94 may verify the z-coordinate (Z) for any calibration point using information not dependent on the z-coordinate or the pressure measurement for the calibration point provided by the mobile device 12. The verification may use a terrain map, as discussed previously herein and as discussed further below with respect to the module 96, to determine a local ground level G corresponding to the horizontal x-, and y-coordinates of the location of a calibration point. The module 94 may use a map (e.g., a street plan) to infer if the horizontal X,Y location for a calibration point may correspond to a building or subway or is away from any large buildings or subway. The module 94 may also use the position method(s) reported in the calibration point and the accuracy of the location in the calibration point to infer a likelihood of the mobile device 12 being outdoors (e.g., a location accurate to within 10 meters that was obtained using A-GNSS would imply being outside of a structure, although possibly in a vehicle, whereas a location obtained using A-GNSS that was only accurate to within 100 meters or a location obtained by measuring WiFi APs that was accurate to within 10 meters would imply being indoors). The module 94 may use the speed or velocity of the mobile device 12 and/or the user motion state reported in the calibration point to further distinguish an outdoor location—e.g., if the mobile device speed is below 30 kph and the motion state is not consistent with being in a subway train or a vehicle, and if the location does not correspond to a building, structure or subway, then the mobile device 12 is probably outdoors. When the available data for a calibration point implies that the mobile device 12 is outdoors, the module 94 may compare the inferred ground level G to the measured z-coordinate. If these are the same or consistent (e.g., if the ground level G is within an uncertainty region for the z-coordinate), the module 94 may conclude that the location corresponds to ground level, that the z-coordinate was therefore measured reliably and may use whichever of z or G is more accurate (e.g., whichever of z or G has smaller uncertainty) to help calibrate the terminal pressure sensor. If G differs from z significantly (e.g., by more than 10 meters), then the module 94 may conclude that the location for the calibration point is probably above or below ground level and thus probably indoors. In this case, the reliability and/or usefulness of z may be reduced and the module 94 may cause the pressure adjustment module 98 (discussed below) to ignore the calibration point. In addition, the module 94 may ignore any calibration point that is potentially indoors and use only reported calibration points for which being outdoors can be reliably inferred (e.g., from a z coordinate that equates to a ground level G, a location that does not correspond to a building, structure or subway and/or a motion state and/or speed or velocity that indicate being outdoors and not in a vehicle) to determine pressure adjustments (e.g., to calibrate the pressure sensor 46). If few or no calibration points are found to be outdoors, then the module 94 may allow the pressure adjustment module 98 to use calibration points whose locations share some common pattern (e.g., Z greater than G by a similar amount). Features of the module 94 may be included in the calibration point filter module 68 (FIG. 4) and vice versa, e.g., to cause the calibration point determination/storage module 66 not to store calibration points that the module 94 would cause the module 98 to ignore.

The server 20 may include the reference barometric module pressure (and map) access module 96. The module 96 may be configured to obtain reference barometric pressure information and/or map information. The module 96 may optionally obtain or be configured with a reference map, e.g., a terrain map and/or a street map. The module 96 may obtain such reference map information from one or more of several sources. For example, the module 96 may contact one or more servers, e.g., one or more servers associated with locations provided in calibration points by the mobile device 12 or otherwise associated with actual locations that the mobile device 12 has visited (e.g., based on locations for reported calibration points).

The module 96 may obtain reference barometric pressure information from one or more of several sources. For example, the module 96 may receive trusted barometric pressure information (e.g. periodically and/or following a query) from reference station(s) 22 and/or from weather bureau 21. Module 96 may also or instead receive barometric pressure information from reference stations corresponding to access points (e.g. AP 16), base stations (e.g. BTS 14), and/or possibly from certain mobile devices 12 as previously described in association with FIG. 1. The module 96 may combine any received pressure measurements, e.g., by averaging reported pressures for the same or similar locations and times received from multiple entities such as mobile devices, access points or base stations, etc. The module 96 may also give priority (e.g. higher weight) to barometric pressure information received from certain sources—e.g. such as weather bureau 21 and/or reference station(s) 22 but possibly not mobile devices 12. For each reference pressure obtained (e.g., received or determined), there may be an associated location and time.

Optionally, the reference barometric pressure access module 96 may provide atmospheric pressure assistance data to the mobile device 12, e.g., to help support altitude determination, by the mobile device 12 and/or help the mobile device 12 to calibrate its pressure sensor (e.g., to help determine a function or lookup table that can provide an adjustment A for any measured pressure P and/or temperature T). The reference atmospheric pressure data may be provided by the module 96 to the mobile device 12 by including the data within an LPPe or LPP/LPPe Provide Assistance Data (PDA) message that is sent to the mobile device 12. An example of the reference atmospheric pressure data is provided in EXHIBIT H, using ASN.1 encoding.

EXHIBIT H

OMA-LPPe-AtmosphericPressureAD ::= SEQUENCE {

| | |
|---|---|
| referencePressure | INTEGER (-20000 . . 10000), |

| | |
|---|---|
| period | SEQUENCE { |

| pressureValidityPeriod | OMA-LPPe-ValidityPeriod, | |
|---|---|---|
| referencePressureRate | INTEGER (-128 . . 127) | OPTIONAL, |

. . .

| | |
|---|---|
| } | OPTIONAL, |
| area | SEQUENCE { |

| pressureValidityArea | OMA-LPPe-PressureValidityArea, | |
|---|---|---|
| gN-pressure | INTEGER (-128 . . 127) | OPTIONAL, |
| gE-pressure | INTEGER (-128 . . 127) | OPTIONAL, |

| . . . | |
|---|---|
| } | OPTIONAL, |

. . .
}

OMA-LPPe-PressureValidityArea ::= SEQUENCE {

| | |
|---|---|
| centerPoint | Ellipsoid-Point, |
| validityAreaWidth | INTEGER (1 . . 128), |
| validityAreaHeight | INTEGER (1 . . 128), |
| . . . | |
| } | |

The OMA-LPPe-AtmosphericPressureAD parameter may be used to provide the reference atmospheric pressure at mean sea level, according to the EGM96 (Earth Gravitational Model 1996), to the mobile device 12. The referencePressure parameter may specify the atmospheric pressure (e.g. in units of Pascals) at mean sea level, EGM96 to the mobile device 12. In some embodiments, the value in the referencePressure parameter may be added to a nominal pressure (e.g. 101325 Pascals). If the pressureValidityArea parameter is provided, the referencePressure parameter may apply to the center of an area (e.g. a rectangular area) defined by the pressureValidityArea parameter. In that case, the pressure within the area outside the center may be calculated using the pressure gradient parameters gN-pressure and gE-pressure (discussed below), if provided. If the pressure gradient gradients are not provided, then the pressure may be assumed to be constant at each location throughout the area. If the pressureValidityArea parameter is not present, the provided atmospheric reference pressure may only be valid at the current position of a recipient mobile device 12.

The pressureValidityPeriod parameter in Exhibit H, if present, specifies the start time and duration of a reference pressure validity period, e.g. the window of time during which the referencePressure parameter is valid. If the pressureValidityPeriod parameter is not present, then the atmospheric pressure assistance data may be treated as valid only at precisely the time the assistance data is received by the mobile device 12. The referencePressureRate parameter in Exhibit H specifies the rate of change of pressure with time. If this parameter is present, then the referencePressure parameter may apply only at the start of the pressureValidityPeriod. The scale factor for the referencePressureRate parameter may be 10 Pascals per hour in one embodiment. As already described, the pressureValidityArea parameter in Exhibit H specifies the area within which the provided atmospheric reference pressure is valid. In the case of Exhibit H, the area is a rectangle defined by its center point (centerPoint parameter), width (validityAreaWidth parameter), and height (validityAreaHeight parameter). Width may be measured from the center along a line of latitude and height may be measured from the center along a line of longitude. Width and height may be measured as the total width and height of the rectangle. The scale factor in this example may be one kilometer. The gN-pressure parameter may specify the northward gradient of the reference pressure calculated from the center of the area defined by the pressureValidityArea parameter. The scale factor of gN-pressure in this example may be 10 Pascals/Km. If this parameter is not provided, then the gradient may be assumed to be zero. The gE-pressure parameter may specify the eastward gradient of the reference pressure calculated from the center of the area defined by the pressureValidityArea parameter. The scale factor of gE-pressure in this example may be 10 Pascals/Km. If this parameter is not provided, then the gradient may be assumed to be zero.

The server 20 may include the pressure adjustment module 98. The pressure adjustment module may be configured to use the calibration point information, as possibly filtered by the calibration point filter module 68 (in the mobile device 12 that provided the calibration point information to the server 20) and/or the calibration point filter module 94, and the known reference barometric data (as obtained by the module 96) to calibrate and/or adjust the current pressure measurement P and optionally an associated adjustment A received from the mobile device 12. For each available (e.g., filtered) calibration point, the pressure adjustment module 98 may use the specified location and the specified date and time for the calibration point to determine, using the reference pressure data (including location, date, and time) obtained by the module 96, a predicted pressure—that is the pressure that should have been measured at the location and the corresponding date and time specified in the calibration point. The module 98 may compare the predicted pressure with the pressure specified in the calibration point (e.g., P or P+A) to determine whether the pressure sensor 46 of the mobile device 12 and the adjustment parameter A (if provided) are accurate or need some additional adjustment. For example, the module 98 may determine a relationship between the predicted pressure and the reported pressure (e.g., either P or P+A) for each calibration point. The comparison of predicted and reported pressure may also take into account any temperature T reported for a calibration point. Thus, the determined relationship may be a fixed number or may vary as a function of temperature and/or one or more other parameters. For example, the module 98 may determine a difference between the predicted pressure and the reported pressure (either P or P+A) in a calibration point associated with a temperature T reported in the calibration point, and determine a calibration value CV as a fixed constant or as a function of temperature, pressure or pressure and temperature. As an example, if the predicted pressure is consistently greater than or consistently less than the measured pressure P or the adjusted pressure P+A by a fixed value V independent of temperature T and pressure P, then CV may be set to V. If the difference between the predicted pressure and the measured pressure P or adjusted pressure P+A increases or decreases with increasing (or decreasing) temperature T in a predictable manner (e.g., as a simple function of T), then CV may be set to some function of T. If the difference between the predicted pressure and the measured pressure P or adjusted pressure P+A increases or decreases with increasing (or decreasing) pressure P in a predictable manner (e.g., as a simple function of P), then CV may be set to some function of P. CV may also be determined as a function of P and T if the difference between predicted and reported pressure varies with both change in P and change in T. In determining a value or function for CV, the difference between the predicted and reported pressure may be subject to averaging (e.g., to reduce the effect of random errors or “noise” in a measured pressure P). The pressure adjustment module 98 may send the determined calibration value CV (e.g., expressed as a constant value, a lookup table indexed on temperature and/or pressure, or as a function of temperature and/or pressure) to the mobile device 12, e.g., so that the mobile device 12 (e.g., the pressure adjustment/recalibration module 64) may create or modify the adjustment parameter A. In some embodiments, the module 98 may use external calibration data (e.g. provided by a vendor of mobile device 12 or a vendor of pressure sensor 46) to determine or help determine the calibration value CV.

The altitude determination module 100 for the server 20 is configured to determine the altitude of the mobile device 12 using the present pressure (P or P+A) reported by the mobile device 12, the calibration value CV determined by the pressure adjustment module 98, if present, and a reference barometric pressure (e.g. which may be provided by module 96) for the time of measurement of the pressure by the mobile device 12 and the horizontal location of the mobile device 12 at that time. The altitude determination module 100 may first convert the calibration value CV to a constant if the calibration value CV is not a constant but a function (e.g. of temperature and/or of pressure). For example, the altitude determination module may use a temperature T provided by the mobile device 12 for the present pressure (P or P+A) and/or the present pressure (P or P+A) to determine a constant value for the calibration value CV when CV (as provided by module 98) is a function of pressure and/or of temperature. In some embodiments, the conversion of CV from a function to a constant may be performed by module 98 and not by module 100. The module 100 may then determine the altitude of the mobile device by determining a compensated pressure (CP) at the mobile device by combining the present pressure P reported by the mobile device 12, any adjustment parameter A that is also reported (which may depend on the reported temperature at the mobile device 12 at the time of measurement of the present pressure P), and the calibration value CV constant determined by the pressure adjustment module 98 and/or by module 100. As an example, the module 100 may determine that CP=P+A+CV when A is reported or that CP=P+CV when A is not reported or is considered not to be trustworthy and not to be used, where both A (if used) and CV are signed values (i.e., positive, negative or zero values). Determining in the module 100 that the calibration value CV has a value of zero may be equivalent to deciding in the module 100 not to apply (e.g. not to determine) the calibration value CV. The altitude of the mobile device 12 may be determined by the altitude determination module 100 using the compensated pressure CP and a known reference pressure (RP) for the present horizontal location of the mobile device 12 and the present time. For example, RP may be obtained from a weather bureau 21 and/or from reference station(s) 22 (e.g., by the module 96) as previously described and may be adjusted (e.g., using pressure gradient information based on time and/or distance) to compensate for any difference between a horizontal location and time applicable for an initial reference pressure and the present location of the mobile device 12 and the present time. By using a known relationship of atmospheric pressure to altitude (e.g., which may depend on temperature and humidity), the altitude at which the pressure determined from the known reference pressure RP equals the compensated pressure CP will provide an estimate of the altitude of the mobile device 12. In some embodiments, the altitude determination module 100 may further make use of any confidence C and/or any pressure range or offset R for the current pressure measurement P (or P+A) provided by the mobile device 12 to help determine an accuracy or uncertainty for the determined altitude.

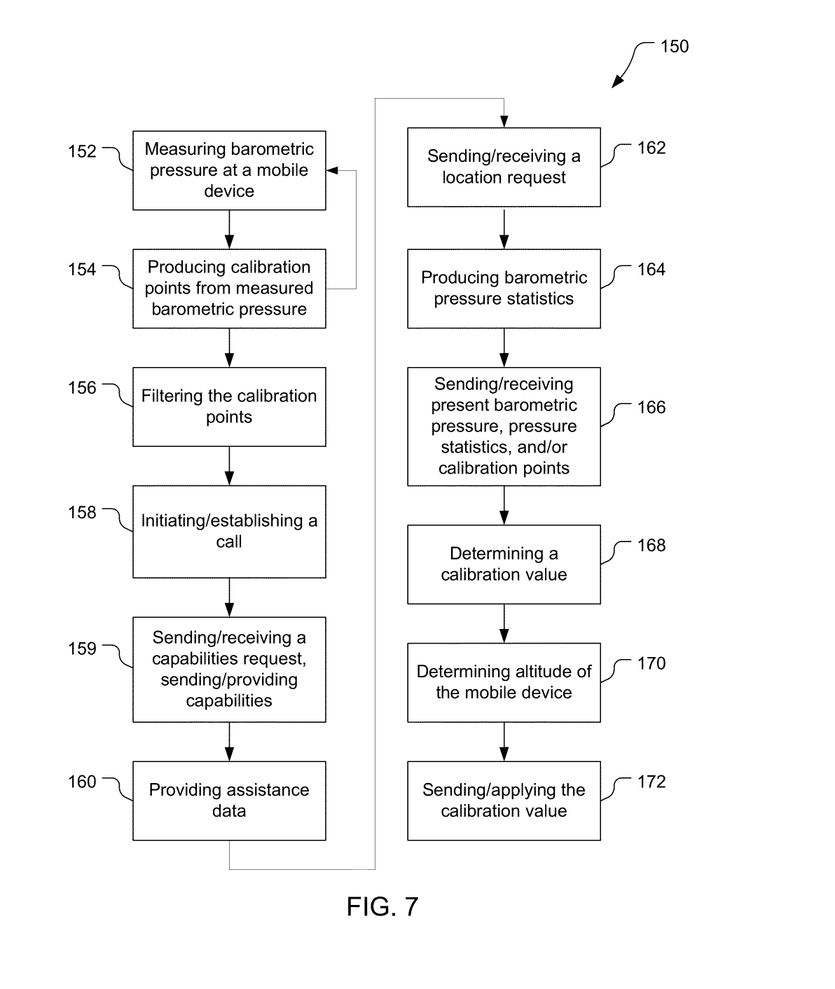

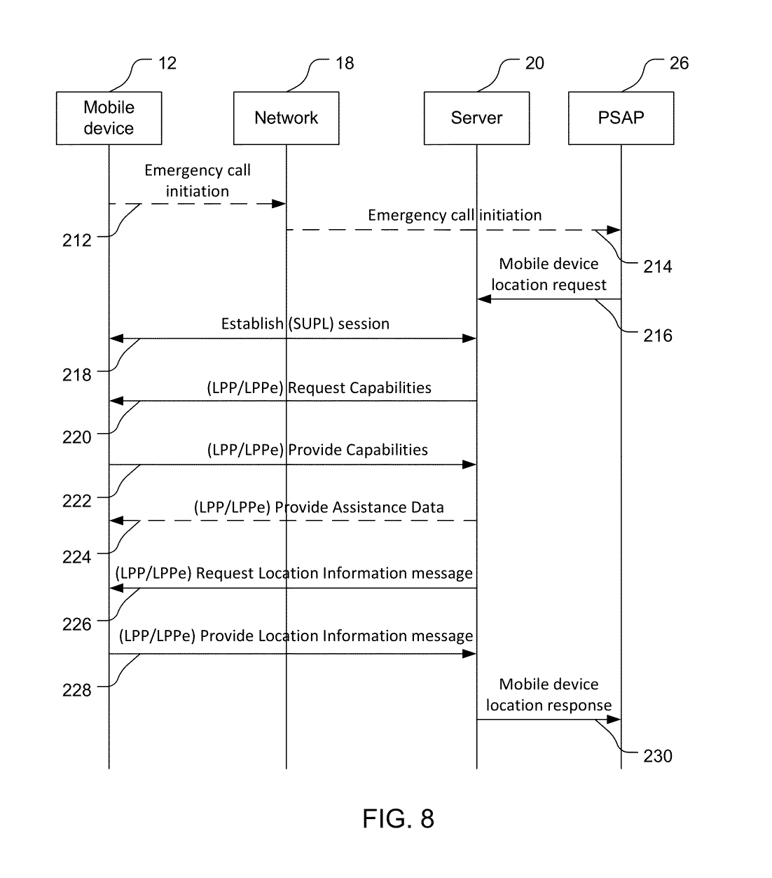

Referring to FIGS. 7-8, with further reference to FIGS. 1-6, a process 150 for determining altitude of a mobile device 12 includes the stages shown. The process 150 may be performed by a mobile device 12 and server 20 and is an example only and not limiting. The process 150 can be altered, e.g., by having stages added, removed, rearranged, combined, performed concurrently, and/or having single stages split into multiple stages. For example, one or more of stages 154, 156, 158, 159, 160, 162, 164, 168, 172, and/or portions of stage 166 may be omitted. Further, stages 170, 172 may be performed concurrently, or stage 172 performed before stage 170. Further still, filtering of calibration points may be performed in stage 168 but not in stage 156, in stage 156 but in stage 168, or in both stages or neither stage. Still other alterations to the process 150 as shown and described are possible. FIGS. 7 and 8 illustrate different aspects of the same process 150. For example, FIG. 8 shows external signaling and messaging aspects while FIG. 7 shows internal processing aspects.

At stage 152, the process 150 includes measuring barometric pressure at a mobile device 12. The pressure sensor 46 measures the barometric pressure at the mobile device 12 and optionally applies an internal adjustment to the measured barometric pressure. The barometric pressure measurement module 62 measures the pressure P and the pressure adjustment/recalibration module 64 determines (e.g., retrieves from memory), and optionally applies, the adjustment A.

At stage 154, the process 150 optionally includes producing and storing a calibration point for the barometric pressure (P or P+A) measured at stage 152. The calibration point is produced and stored by the calibration point determination/storage module 66 discussed above and may include the barometric pressure P output by the pressure sensor 46, the adjustment A, the current location of the mobile device 12 (e.g., as determined by any method such as A-GNSS that does not depend on the pressure measurement P), the current date and time, the temperature T at the mobile device 12 at the time of measurement of the barometric pressure, motion state(s) (as determined by the motion state(s) determination module 70) of the mobile device 12, and/or the speed or velocity of the mobile device 12. Stages 152 and 154 may be repeated at a number of different times (e.g. once each hour, once each day) to obtain and store a sequence of calibration points for a sequence of different times.

At stage 156, the process 150 optionally includes filtering the calibration points obtained and/or stored at stage 154. The calibration point filter module 68 filters the calibration points, preferably discounting, ignoring, not storing or not transmitting to the server 20 at stage 166, calibration points that do not have useful or reliable pressures and/or do not have useful or reliable locations associated with them, e.g., calibration points that do not have high confidence of being outdoors or calibration points that do not have accurate x, y and z location coordinates. In some embodiments, stage 156 may be performed in combination with or immediately prior to stage 166.

At stage 158, the process 150 optionally includes initiating/establishing an emergency call from the mobile device 12 to a PSAP 26 (e.g., in response to the user of mobile device 12 dialing an emergency number such as “911” or “112”). In this case, the communication setup/capabilities module 60 of the mobile device 12 initiates the emergency call as shown in FIG. 8 at 212, by sending an emergency call initiation indication to the network 18. The emergency call initiation indication at 212 may comprise a request for an emergency call, a request to perform emergency related signaling (e.g., to obtain an emergency RF signaling link), an emergency call setup message (e.g., a SIP INVITE message), some combination of these or some other emergency related indication. The network 18 may respond by forwarding at 214 an emergency call initiation request or message to a suitable PSAP 26 (e.g., a PSAP associated with a current location and/or current serving cell for the mobile device 12). In some embodiments, the emergency call initiation request or message sent at 214 may convey an address or identity for the server 20 to the PSAP 26 and an identity, address or reference (e.g. a telephone number) for the mobile device 12. Further signaling may then occur between mobile device 12, network 18 and PSAP 26 to establish the emergency call (not shown in FIG. 8).

The PSAP 26 may respond to the emergency call initiation or establishment by sending at 216 a location request to the server 20 for the current location of the mobile device 12. The location request at 216 may be routed to the server 20 and may identify the mobile device 12 according to information received in the emergency call initiation request or message sent at 214. In turn, the positioning setup module 90 of the server 20, possibly assisted by the communication setup/capabilities module 60 of the mobile device 12, may establish at 218 a communication session (e.g., a SUPL session) between the server 20 and the mobile device 12 (e.g., the communication setup/capabilities module 60 of the mobile device 12). In some embodiments, the communication session (e.g. SUPL session) between server 20 and mobile device 12 may be established at 218 in response to the emergency call initiation at 212—e.g. if network 18 makes use of server 20 (not shown in FIG. 8) to help route the emergency call request to the PSAP 26 at 214. In that case, 218 and some or all of 220-228 may occur prior to the location request from PSAP 26 at 216. If 228 then occurs prior to 216, server 20 may store any location information for mobile device 12 received at 228 and/or determined from information received at 228 (e.g. including an altitude for mobile device 12) and may provide the stored location information to PSAP 26 at 230 after 216 has occurred.

At stage 159 in FIG. 7 and at 220 in FIG. 8, the process 150 includes sending/receiving a capabilities request and sending/receiving capabilities. The location information/capabilities request module 92 of the server 20 may send, and the mobile device 12 may receive, a Request Capabilities message (e.g., an LPP or LPP/LPPe Request Capabilities message) requesting positioning capabilities of the mobile device 12, e.g., regarding the ability of the mobile device 12 to provide barometric pressure information in association with LPP or LPP/LPPe. The communication setup/capabilities module 60 of the mobile device 12 may respond at stage 159 in FIG. 7 and at 222 in FIG. 8 by sending, and the server 20 receiving, a Provide Capabilities message (e.g., an LPP or LPP/LPPe Provide Capabilities message) containing capabilities of the mobile device 12, e.g., regarding the ability of the mobile device 12 to provide barometric pressure information. For example, this message may include the OMA-LPPe-Sensor-ProvideCapabilities parameter discussed above with respect to EXHIBIT A.

At stage 160 in FIG. 7 and at 224 in FIG. 8, the process 150 optionally includes the server 20 providing assistance data. The server 20 may send a Provide Assistance Data (PAD) message (e.g., an LPP or LPP/LPPe PAD message) to the mobile device 12 with assistance data. For example, the assistance data may include data to assist the mobile device 12 to perform measurements and/or to obtain a location estimate using A-GNSS, OTDOA, E-CID, WLAN/WiFi positioning, SRN positioning or some other position method. In an embodiment, the PAD message may contain assistance data related to barometric pressure measurement such as that described previously for Exhibit H. The mobile device 12 may use the assistance data (e.g. following 160 or following the location request at 226) to help make measurements for position methods such as A-GNSS, OTDOA, E-CID, WLAN/WiFi and/or SRN and may, in some embodiments, use the assistance data to help determine a location of the mobile device 12 from these measurements—e.g., a horizontal location comprising x and y coordinates but not necessarily a z coordinate.

At stage 162 in FIG. 7 and at 226 in FIG. 8, the process 150 optionally includes sending/receiving a location request. For example, the stage 162 may include the location information/capabilities request module 92 of the server 20 sending, and the mobile device 12 receiving, at 226 in FIG. 8 a Request Location Information (RLI) message (e.g., an LPP or LPP/LPPe RLI message) to request location information from the mobile device 12. The RLI message may, for example, include the OMA-LPPe-Sensor-RequestLocationlnformation parameter discussed with respect to EXHIBIT G. The RLI message may further include a request for other location information—e.g., (i) a request for A-GNSS measurements, OTDOA measurements, E-CID measurements, WLAN/WiFi measurements and/or SRN measurements; or (ii) a request for a location estimate determined using A-GNSS measurements, OTDOA measurements, E-CID measurements, WLAN/WiFi measurements, SRN measurements or other measurements.

At stage 164 in FIG. 7, the process 150 optionally includes producing barometric pressure statistics by the mobile device 12. The pressure statistics determination module 72 of the mobile device 12 determines barometric pressure statistics such as those discussed with respect to EXHIBIT E. This may occur during a short period (e.g., 5 to 40 seconds) during which the mobile device 12 is obtaining other measurements or location information requested at 162 and at 226—e.g., measurements or a location estimate determined using A-GNSS, OTDOA, E-CID, WLAN/WiFi and/or SRN.

At stage 166 in FIG. 7 and at 228 in FIG. 8, the process 150 includes sending/receiving present barometric pressure, pressure statistics, and/or calibration points. The process 150 includes the mobile device 12 sending, and the server 20 receiving, at 228 in FIG. 8 barometric pressure information. For example, the reporting module 74 of the mobile device 12 may send a Provide Location Information (PLI) message (e.g., an LPP or LPP/LPPe PLI message) at 228 with some or all of the information requested in the RLI message from the server 20 received at 226. The PLI message may include the OMA-LPPe-AtmosphericPressure parameter discussed above with respect to EXHIBIT F. Stage 166 in FIGS. 7 and 228 in FIG. 8 optionally further includes sending by the mobile device 12 in the PLI message, and receiving by the server 20, one or more of the optional fields of the OMA-LPPe-AtmosphericPressure parameter discussed above with respect to EXHIBIT F, that is the PressureStats parameter discussed with respect to EXHIBIT E, the OMA-LPPe-PressureMeasurement parameter for current pressure measurement information discussed with respect to Exhibit C, and/or the CalibrationPoints parameter discussed with respect to EXHIBIT B. In the case of sending calibration points using the CalibrationPoints parameter of Exhibit C, the CalibrationPoints parameter may include, for each calibration point that is provided, the OMA-LPPe-PressureMeasurement parameter discussed with respect to EXHIBIT C and optionally the OMA-LPPe-Sensor-MotionStateList parameter discussed with respect to EXHIBIT D. The PLI message sent/received at stage 166 and at 228 may include additional information if requested in the RLI message at 226 such as measurements or a location estimate (e.g., a 2D or 3D location estimate) determined used one or more positioning methods such as A-GNSS, OTDOA, E-CID, WLAN/WiFi and/or SRN.

At stage 168, the process 150 optionally includes determining a calibration value (CV) at the server 20. The calibration point filter module 94 may optionally filter any calibration points received at 228 from the mobile device 12 as described previously (e.g. by including only calibration points for outdoor locations and/or only calibration points with an accurate 3D location). The pressure adjustment module 98, in conjunction with information provided by the reference barometric pressure (and map) access module 96, may then determine the calibration value CV using the calibration points or filtered calibration points, as discussed above, for adjusting the current barometric pressure provided by the reporting module 74 of the mobile device 12 at stage 166 and at 228.

At stage 170, the process 150 includes determining an altitude of the mobile device 12. The altitude determination module 100 of the server 20 uses the present barometric pressure (e.g. including the current pressure measurement P, the adjustment A, the confidence C, the pressure range or offset R and/or the temperature T) reported by the reporting module 74 of the mobile device 12 at stage 166 and 228, a reference pressure, and optionally the calibration value CV, to determine the altitude of the mobile device 12 using one or more known altitude-pressure relationships and as described previously. In order to make use of the reference pressure, the altitude determination module 100 may need to know the horizontal 2D location of the mobile device 12—e.g., in order to correctly adjust a reference pressure for a different horizontal location to the horizontal location of the mobile device 12. The horizontal 2D location of the mobile device 12 may be obtained by the altitude determination module 100 and/or by server 20 from any additional location measurements and/or location estimate included by the mobile device 12 in the PLI message sent at stage 166 and at 228 or may be obtained from information already known to server 20 such as a serving cell for mobile device 12 which may have been provided to server 20 by network 18. In some embodiments, additional location measurements and/or a location estimate to help server 20 determine a 2D location for mobile device 12 may be sent by mobile device 12 to server 20 in a different PLI message (not shown in FIG. 8) to the PLI message sent at 228.

The process 150 includes the server 20 sending, and the PSAP 26 receiving, at 230 in FIG. 8 a mobile device location response that includes at least the altitude determined for the server 20 (e.g. by module 100) at stage 170 and may further include, or combine the altitude with, a horizontal 2D location for the mobile device 12 (e.g., determined by the server 20 from other information provided by the PLI message received at 228).

At stage 172, the process 150 optionally includes sending/applying the calibration value. The pressure adjustment module 98 may send the calibration value CV determined at stage 168 to the mobile device 12 (e.g., using an LPP or LPP/LPPe message such as an LPP/LPPe PAD message not shown in FIG. 8). The pressure adjustment/recalibration module 64 of the mobile device 12 may then create or modify an adjustment parameter A for later pressure measurements by mobile device 12 (e.g. by pressure sensor 46) based on the provided calibration value CV, (e.g., if CV is a constant then a new adjustment parameter A may be set to an old adjustment parameter A plus the calibration value CV).

The process 150 exemplified in FIGS. 7 and 8 assumes that the server 20 establishes a SUPL session with the mobile device 12 at 218 in FIG. 8 and that subsequent communication between server 20 and mobile device 12 (e.g., at 220, 222, 224, 226 and 228) is conducted as part of this SUPL session. However, in a different example of the process 150, the server 20 may employ a control plane location solution (e.g., the control plane location solution defined by 3GPP for LTE in 3GPP TSs 23.271 and 36.305) rather than using SUPL. In this example, the server 20 may be an E-SMLC rather than an SLP, event 218 may not occur and events 220, 222, 224, 226 and 228 (and some or all stages in FIG. 7) may still occur but as part of a control plane session between the server 20 and mobile device 12 rather than as part of a SUPL session. Similarly, the process 150 as shown assumes that the mobile device 12 initiates an emergency call at stage 158 in FIG. 7 and at 212 in FIG. 8. However, in a different example of the process 150, the mobile device 12 may not initiate an emergency call but may instead send a request to a network (e.g., the network 18) or to the server 20 for the current altitude of the mobile device 12 and possibly the current horizontal location of the mobile device 12. The server 20 (e.g., if requested by the network 18 or by the mobile device 12) and the mobile device 12 may then perform the communication and positioning shown at 218, 220, 222, 224, 226 and 228 in FIG. 8 (and may perform some or all stages in FIG. 7 with the exception of stage 158 which may not occur) or may perform similar communication and positioning for a control plane location solution as already mentioned. Following event 228, the server 20 may return a computed altitude (and possibly a horizontal 2D location) to the mobile device 12. In another example of the process 150, the mobile device 12 may not initiate an emergency call at 212 in FIG. 8 and at stage 158 in FIG. 7, but instead some external client (not shown in FIG. 8) may request the altitude and possibly the horizontal 2D location of the mobile device 12 at 216 instead of the PSAP 26. Events 218, 220, 222, 224, 226, 228 may then occur as shown in FIG. 8 (and some or all stages in FIG. 7 may then occur with the exception of stage 158), or events similar to events 218, 220, 222, 224, 226, 228 (or stages similar to some or all stages in FIG. 7 except for stage 158) may occur in association with a control plane location solution as already remarked. Then at event 230 in FIG. 8, the server 20 may return the altitude of the mobile device 12 and possibly a horizontal 2D location to the external client instead of to the PSAP 26. These different examples of the process 150 may use the same method to determine the altitude of the mobile device 12 but may support different location-related services on behalf of different clients and/or other means of coordinating and communicating positioning related information between the server 20 and the mobile device 12 than the process exemplified in FIGS. 7 and 8.

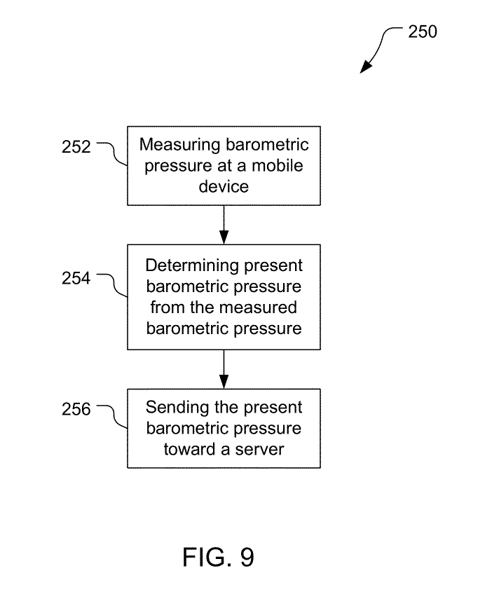

Referring to FIG. 9, with further reference to FIGS. 1-8, a process 250 for providing pressure information from a mobile device 12 includes the stages shown. The process 250 is, however, an example only and not limiting. The process 250 can be altered, e.g., by having stages added, removed, rearranged, combined, performed concurrently, and/or having single stages split into multiple stages.

At stage 252, the process 250 includes measuring barometric pressure at a mobile device 12. The pressure sensor 46 measures the barometric pressure at the mobile device 12 and optionally applies an internal adjustment to the measured barometric pressure. The barometric pressure measurement module 62 measures the pressure P (or obtains the pressure P from the pressure sensor 46) and optionally applies an adjustment A to the pressure to produce an adjusted pressure P+A.

At stage 254, the process 250 includes determining present barometric pressure from the measured barometric pressure (e.g., P or P+A). The present barometric pressure is determined as the measured barometric pressure P or the measured barometric pressure and the adjustment parameter P+A.

At stage 256, the process 250 includes sending the present barometric pressure (e.g., comprising P, A and/or P+A) toward a server 20. For example, the reporting module 74 of the mobile device 12 may send a Provide Location Information (PLI) message (e.g. an LPPe or LPP/LPPe PLI message) including the present barometric pressure, e.g., at stage 228 shown in FIG. 8.

Optionally, the process 250 may include further operations. For example, the sending at stage 256 may further include sending calibration points including one or more parameters as discussed above. The sending may further include filtering the calibration points sent toward the server. For example, only those calibration points whose three-dimensional (3D) locations are determined to be outdoors (e.g., with at least a threshold level of confidence), and/or whose 3D locations have an uncertainty that is less than some threshold may be sent from the mobile device 12 toward the server 20. Also or alternatively, pressure statistics may be determined by the pressure statistics determination module 72 and sent by the reporting module 74 of the mobile device 12 toward the server 20 as part of stage 256. Also or alternatively, the reporting module 74 may send a recalibration indication, indicative of a most-recent recalibration of the pressure sensor 46 that occurred after all date and time combinations in all calibration points that were sent to the server 20.

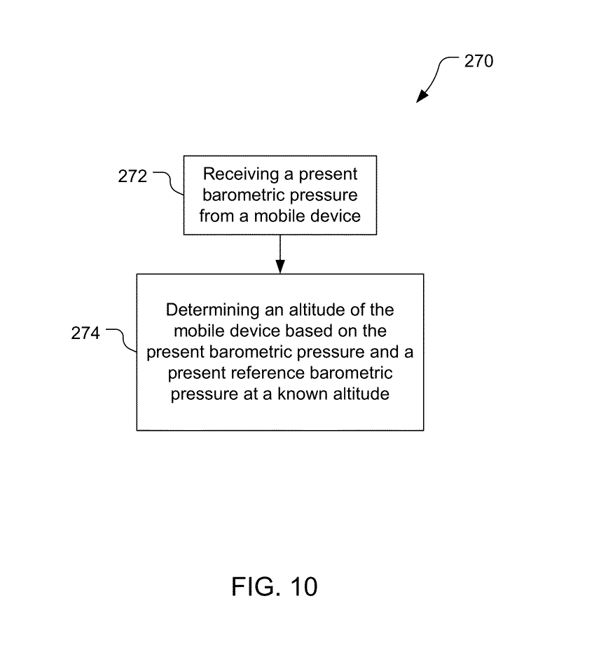

Referring to FIG. 10, with further reference to FIGS. 1-8, a process 270 for receiving pressure information from a mobile device 12 at a server 20 includes the stages shown. The process 270 is, however, an example only and not limiting. The process 270 can be altered, e.g., by having stages added, removed, rearranged, combined, performed concurrently, and/or having single stages split into multiple stages.

At stage 272, the process 270 includes receiving a present barometric pressure from a mobile device 12. The mobile device 12 sends, and the server 20 receives the present barometric pressure (e.g., the measured pressure P or the measured pressure adjusted by the adjustment parameter P+A) that exists at the mobile device 12.

At stage 274, the process 270 includes determining an altitude of the mobile device 12 based on the present barometric pressure and a present reference barometric pressure at a known altitude. The altitude determination module 100 uses a known relationship between pressure and altitude (e.g., as a function of temperature and/or humidity) and determines the altitude of the mobile device 12 based on a known pressure at a known altitude, the present barometric pressure at the mobile device 12, and the relationship between pressure and altitude.

Optionally, the process 270 may include further operations. For example, the server 20 may receive calibration points, from the mobile device 12 as part of stage 272, including one or more parameters as discussed above and may use the calibration points to determine a calibration value (CV) to apply to and adjust the present barometric pressure. The server 20, e.g., the calibration point filter module 94, may select which of the calibration points to use to determine the calibration value, e.g., based on whether a calibration point corresponds to an outdoor location (e.g., within a threshold confidence) and/or has a 3D location with an uncertainty that is less than some threshold value. Also or alternatively, the server 20 may receive pressure statistics for present barometric pressures and may determine the altitude of the mobile device 12, in part, using the pressure statistics.

Other Considerations

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

A statement that information is sent to or toward a destination does not require specific directionality of a transmission (e.g., does not require a wireless transmission to be sent from a source of the transmission in the direction of the destination). Further, such as statement does not require completion of a transmission of the information. The complete transmission may be through one or more intermediaries and may, at one or more intermediate nodes, be sent in a direction at least partially away from the destination.

Further, a statement about a location, pressure, temperature, uncertainty, or other feature being sent, received, included, etc. implies, where appropriate, that one or more indications of the respective feature is sent, received, included, etc. That is, if “indication” is not explicitly used, but is appropriate, then “indication” is implicit but omitted for clarity and/or ease of reading.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Features may be performed at locations different than those discussed above. For example, determination of motion state(s) of the mobile device may be performed at the server 20, with the mobile device 12 providing sufficient information for the server 20 to make the determination.

Substantial variations to described configurations may be made in accordance with specific requirements. For example, customized hardware may also be used, and/or particular elements may be implemented in hardware, software (including portable software, such as applets, etc.), or both. Further, connection to other computing devices such as network input/output devices may be employed.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a non-transitory storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the techniques presented by example herein. Also, a number of operations may be undertaken before, during, or after the above elements are considered.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is lower than or is within) a first threshold value is equivalent to a statement that the value is less than or equal to a second threshold value that is slightly lower than the first threshold value, e.g., the second threshold value being one value lower than the first threshold value in the resolution of a computing system.

1. A method of determining, at a server, an altitude of a mobile device, the method comprising:
receiving, at the server from the mobile device, a present barometric pressure at the mobile device; and
determining, at the server, the altitude of the mobile device based on the present barometric pressure and a present reference barometric pressure at a known altitude.

2. The method of claim 1, further comprising:
receiving from the mobile device a plurality of calibration points each including a three-dimensional location of the mobile device and a then-present barometric pressure at the mobile device;
determining an adjustment to the present barometric pressure based on the plurality of calibration points and historic reference barometric pressure information; and
applying the adjustment when not zero to the present barometric pressure before determining the altitude of the mobile device.

3. The method of claim 2, wherein each of the plurality of calibration points further includes a date and time combination corresponding to the three-dimensional location and the then-present barometric pressure.

4. The method of claim 3, wherein each of the plurality of calibration points further includes at least one of (1) a speed of the mobile device corresponding to the date and time, (2) a velocity of the mobile device corresponding to the date and time, (3) motion state information for the mobile device corresponding to the date and time, (4) one or more techniques used to determine the three-dimensional location of the mobile device, (5) an uncertainty of the three-dimensional location of the mobile device, or (6) an indication as to whether the mobile device recalibrated a pressure sensor output of a pressure sensor of the mobile device based on the three-dimensional location and the then-present barometric pressure.

5. The method of claim 4, wherein the uncertainty is an uncertainty volume.

6. The method of claim 4, further comprising determining for each of the plurality of calibration points whether the three-dimensional location is outdoors, wherein the determining the adjustment to the present barometric pressure is based only on the plurality of calibration points, of the plurality of calibration points, whose three-dimensional location is determined to be outdoors.

7. The method of claim 4, further comprising discounting or ignoring calibration points with date and time combinations before a most-recent of the plurality of calibration points that includes an indication that the mobile device recalibrated the pressure sensor output based on the three-dimensional location and the then-present barometric pressure.

8. The method of claim 2, further comprising receiving, at the server from the mobile device, present barometric pressure statistics at the mobile device, wherein determining the altitude of the mobile device is based at least in part on the present barometric pressure statistics.

9. A server comprising:
an antenna;
a transceiver communicatively coupled to the antenna and configured to send and receive wireless signals via the antenna; and
a processor, communicatively coupled to the transceiver and configured to:
receive, from a mobile device via the antenna and the transceiver, a present barometric pressure at the mobile device; and
determine an altitude of the mobile device based on the present barometric pressure and a present reference barometric pressure at a known altitude.

10. The server of claim 9, wherein the processor is further configured to:
receive from the mobile device a plurality of calibration points each including a three-dimensional location of the mobile device and a then-present barometric pressure at the mobile device;
determine an adjustment to the present barometric pressure based on the plurality of calibration points and historic reference barometric pressure information; and
apply the adjustment when not zero to the present barometric pressure before determining the altitude of the mobile device.

11. The server of claim 10, wherein each of the plurality of calibration points further includes a date and time combination corresponding to the three-dimensional location and the then-present barometric pressure.

12. The server of claim 11, wherein each of the plurality of calibration points further includes at least one of (1) a speed of the mobile device corresponding to the date and time, (2) a velocity of the mobile device corresponding to the date and time, (3) motion state information for the mobile device corresponding to the date and time, (4) one or more techniques used to determine the three-dimensional location of the mobile device, (5) an uncertainty of the three-dimensional location of the mobile device, or (6) an indication as to whether the mobile device recalibrated a pressure sensor output of a pressure sensor of the mobile device based on the three-dimensional location and the then-present barometric pressure.

13. The server of claim 12, wherein the uncertainty is an uncertainty volume.

14. The server of claim 12, wherein the processor is further configured to:
determine for each of the plurality of calibration points whether the three-dimensional location is outdoors; and
determine an adjustment to the present barometric pressure based only on the plurality of calibration points, of the plurality of calibration points, whose three-dimensional location is determined to be outdoors.

15. The server of claim 12, wherein to determine the adjustment to the present barometric pressure the processor is configured to discount or ignore calibration points with date and time combinations before a most-recent of the plurality of calibration points that includes an indication that the mobile device recalibrated the pressure sensor output based on the three-dimensional location and the then-present barometric pressure.

16. The server of claim 10, wherein the processor is further configured to determine the altitude of the mobile device based at least in part on present barometric pressure statistics received from the mobile device.

17. A server comprising:
means for receiving, from a mobile device, a present barometric pressure at the mobile device; and
means for determining an altitude of the mobile device based on the present barometric pressure at the mobile device and a present reference barometric pressure at a known altitude.

18. The server of claim 17, wherein:
the means for receiving are further for receiving from the mobile device a plurality of calibration points each including a three-dimensional location of the mobile device and a then-present barometric pressure at the mobile device; and
the means for determining the altitude include means for determining an adjustment to the present barometric pressure based on the plurality of calibration points and historic reference barometric pressure information, and means for applying the adjustment when not zero to the present barometric pressure before determining the altitude of the mobile device.

19. The server of claim 18, wherein each of the plurality of calibration points further includes a date and time combination corresponding to the three-dimensional location and the then-present barometric pressure.

20. The server of claim 19, wherein each of the plurality of calibration points further includes at least one of (1) a speed of the mobile device corresponding to the date and time, (2) a velocity of the mobile device corresponding to the date and time, (3) motion state information for the mobile device corresponding to the date and time, (4) one or more techniques used to determine the three-dimensional location of the mobile device, (5) an uncertainty of the three-dimensional location of the mobile device, or (6) an indication as to whether the mobile device recalibrated a pressure sensor output of a pressure sensor of the mobile device based on the three-dimensional location and the then-present barometric pressure.

21. The server of claim 20, wherein the uncertainty is an uncertainty volume.

22. The server of claim 20, wherein the means for determining the altitude include means for determining for each of the plurality of calibration points whether the three-dimensional location is outdoors, and the means for determining the adjustment to the present barometric pressure are configured to do so using only on the plurality of calibration points, of the plurality of calibration points, whose three-dimensional location is determined to be outdoors.

23. The server of claim 20, wherein the means for determining the adjustment are configured to discount or ignore calibration points with date and time combinations before a most-recent of the plurality of calibration points that includes an indication that the mobile device recalibrated the pressure sensor output based on the three-dimensional location and the then-present barometric pressure.

24. A processor-readable, non-transitory storage medium comprising processor-readable instructions configured to cause a processor to:
receive, from a mobile device, a present barometric pressure at the mobile device; and
determine an altitude of the mobile device based on the present barometric pressure and a present reference barometric pressure at a known altitude.

25. The non-transitory storage medium of claim 24, further comprising instructions configured to cause the processor to:
receive from the mobile device a plurality of calibration points each including a three-dimensional location of the mobile device and a then-present barometric pressure at the mobile device;
determine an adjustment to the present barometric pressure based on the plurality of calibration points and historic reference barometric pressure information; and
apply the adjustment when not zero to the present barometric pressure before determining the altitude of the mobile device.

26. The non-transitory storage medium of claim 25, wherein each of the plurality of calibration points further includes a date and time combination corresponding to the three-dimensional location and the then-present barometric pressure.

27. The non-transitory storage medium of claim 26, wherein each of the plurality of calibration points further includes at least one of (1) a speed of the mobile device corresponding to the date and time, (2) a velocity of the mobile device corresponding to the date and time, (3) motion state information for the mobile device corresponding to the date and time, (4) one or more techniques used to determine the three-dimensional location of the mobile device, (5) an uncertainty of the three-dimensional location of the mobile device, or (6) an indication as to whether the mobile device recalibrated a pressure sensor output of a pressure sensor of the mobile device based on the three-dimensional location and the then-present barometric pressure.

28. The non-transitory storage medium of claim 27, wherein the uncertainty is an uncertainty volume.

29. The non-transitory storage medium of claim 27, further comprising instructions configured to cause the processor to determine for each of the plurality of calibration points whether the three-dimensional location is outdoors, wherein the instructions configured to cause the processor to determine the adjustment to the present barometric pressure are configured to cause the processor to determine the adjustment to the present barometric pressure based only on the plurality of calibration points, of the plurality of calibration points, whose three-dimensional location is determined to be outdoors.

30. The non-transitory storage medium of claim 27, wherein to determine the adjustment to the present barometric pressure the instructions are configured to cause the processor to discount or ignore calibration points with date and time combinations before a most-recent of the plurality of calibration points that includes an indication that the mobile device recalibrated the pressure sensor output based on the three-dimensional location and the then-present barometric pressure.
